(19) United States
(12) Patent Application Publication
(10) Pub. No.: US 2026/0113642 A1
(43) Pub. Date: Apr. 23, 2026

(54) SYSTEM PROVIDED WITH WIDE-AREA CELL BASE STATION AND TERRESTRIAL CELL BASE STATION

(71) Applicant: SoftBank Corp., Tokyo (JP)

(72) Inventors: Koji Tashiro, Tokyo (JP); Tsutomu Ishikawa, Tokyo (JP); Kenji Hoshino, Tokyo (JP); Atsushi Nagate, Tokyo (JP)

(73) Assignee: SoftBank Corp., Tokyo (JP)

(21) Appl. No.: 19/153,975

(22) PCT Filed: Feb. 7, 2024
(86) PCT No.: PCT/JP2024/004129

§ 371 Date: Aug. 6, 2025

(30) Foreign Application Priority Data
Feb. 8, 2023 (JP) 2023-017329

(51) Int. Cl. H04W 16/28; H04W 72/12

(52) U.S. Cl. CPC H04W 16/28; H04W 72/12

(57) ABSTRACT

Provided is a system capable of reducing a residual interference when forming a null of a directional beam from a relay communication station in an upper airspace which forms a wide-area cell toward an antenna of a terrestrial cell base station. The wide-area cell base station and one or plural terrestrial cell base stations perform service link communications in the same frequency band using radio frames that are time-synchronized with each other. The wide-area cell base station determines a null-forming method according to the conditions of uplink (UL) and downlink (DL) of the service link communications that are performed synchronously in the radio frames of the wide-area cell and the terrestrial cell, and controls a beamforming by the service link antenna of the relay communication station so as to form a null toward within a coverage area of the terrestrial cell base station based on the null-forming method.

### TECHNICAL FIELD

The present invention relates to a technology for suppressing an interference to a terrestrial cell from a relay communication station mounted in a HAPS or the like in an upper airspace.

### BACKGROUND ART

There is conventionally known a base station (hereinafter referred to as a “wide-area cell base station”) that forms a wide-area cell toward on the ground or on the sea from a relay communication station of repeater-type or base-station apparatus type which is mounted in a high-altitude platform station (HAPS) (also referred to as a “high-altitude pseudo satellite”) located in a upper airspace, a low earth orbit (LEO) satellite, a geostationary orbit (GEO) satellite or the like. In an environment of mixture of a system (hereinafter referred to as an “upper airspace system”) in which such the foregoing wide-area cell base station performs a service link communication with a UE (terminal) and a system (hereinafter referred to as a “terrestrial system”) in which an existing terrestrial cell base station performs a service link communication with a UE (terminal), if the communications are performed simultaneously using the same frequency band, a signal from the relay communication station in the upper airspace system causes an interference to the terrestrial system. When the interference from this upper airspace system occurs, the throughput of the terrestrial system is significantly reduced. Similarly, a signal from the terrestrial system also causes an interference to the upper airspace system. When the interference from this terrestrial system occurs, the throughput of the upper airspace system is reduced.

Patent Literature 1 discloses a technology for eliminating or avoiding an area covered by the terrestrial cell and suppressing (reducing) the interference to the terrestrial system by adjusting an antenna system of the HAP in the upper airspace to form a directional beam by directing a null toward the terrestrial cell base station based on a map of the eNB (terrestrial cell base station).

### CITATION LIST

### Patent Literature

Patent Literature 1: US Patent Application Publication No. 2017/0272131.

### SUMMARY OF INVENTION

### Technical Problem

In order to suppress (reduce) the interference from the upper airspace system to the terrestrial system and the interference from the terrestrial system to the upper airspace system in the environment of mixture of the upper airspace system and the terrestrial system, it is desired to reduce a residual interference when suppressing the interference by forming the null of the directional beam from the relay communication station of the upper airspace toward the antenna of the terrestrial cell base station.

### Solution to Problem

A system according to an aspect of the present invention is a system comprising a wide-area cell base station that forms a wide-area cell from a service link antenna of a relay communication station mounted in a flying body or floating body located in an upper airspace toward on the ground or on the sea, and one or plural terrestrial cell base stations that form a terrestrial cell from an antenna disposed on the ground or on the sea. The wide-area cell base station and the one or plural terrestrial cell base stations perform service link communications in the same frequency band using radio frames that are time-synchronized with each other. The wide-area cell base station determines a null forming method according to conditions of uplink (UL) and downlink (DL) of the service link communications that are performed synchronously in the radio frames of the wide-area cell and the terrestrial cell, and controls a beamforming by the service link antenna of the relay communication station so as to form a null toward within a coverage area of the terrestrial cell base station based on the null forming method.

In the foregoing system, the number of the terrestrial cell base stations may be plural, and the wide-area cell base station may switch the null forming method for the plural terrestrial cell base stations depending on the conditions of uplink (UL) and downlink (DL) of the service link communications.

In the foregoing system, the wide-area cell base station may select a null forming method for forming a single null toward the antenna of the terrestrial cell base station, with respect to radio resources in which communication directions of the uplink (UL) and the downlink (DL) are different between the wide-area cell and the terrestrial cell, among radio resources in the radio frame of the own station.

In the foregoing system, the wide-area cell base station may select a null forming method for switching and forming nulls for each of the terrestrial cells according to at least one of time and frequency, with respect to radio resources in which communication directions of the uplink (UL) and the downlink (DL) are the same between the wide-area cell and the terrestrial cell, among radio resources in the radio frame of the own station. Herein, the wide-area cell base station may change the number of nulls to be switched and formed for each of the terrestrial cells.

In the foregoing system, the wide-area cell base station may select a null forming method for forming plural nulls at the same time for each of the terrestrial cells, with respect to radio resources in which communication directions of the uplink (UL) and the downlink (DL) are the same between the wide-area cell and the terrestrial cell, among radio resources in the radio frame of the own station. Herein, the wide-area cell base station may change the number of nulls to be formed at the same time for each of the terrestrial cells.

In the foregoing system, the wide-area cell base station may select a null forming method for switching and forming null groups for each of the terrestrial cells according to at least one of time and frequency when forming plural nulls at the same time for each of the terrestrial cells, with respect to radio resources in which communication directions of the uplink (UL) and the downlink (DL) are the same between the wide-area cell and the terrestrial cell, among radio resources in the radio frame of the own station. Herein, the wide-area cell base station may change, for each of the terrestrial cells, at least one of the number of nulls to be formed at the same time and the number of nulls to be switched and formed.

In the foregoing system, each of the plural terrestrial cell base stations may perform the service link communication by a Time Division Duplex (TDD) method, and transmit switching information on uplink (UL) and downlink (DL) of the own cell, to the wide-area cell base station, and the wide-area cell base station may receive the switching information on uplink (UL) and downlink (DL) from each of the plural terrestrial cell base stations, obtain information related to terrestrial cell base stations located in the wide-area cell from a terrestrial cell base station database, determine a null scheduling regarding an allocation of nulls on a time axis and a frequency axis for each of the terrestrial cell base stations, based on the switching information on uplink (UL) and downlink (DL) received from each of the plural terrestrial cell base stations and the information related to terrestrial cell base stations obtained from the terrestrial cell base station database, and transmit null scheduling information to each of the plural terrestrial cell base stations, and each of the plural terrestrial cell base stations may receive the null scheduling information related to the own terrestrial cell base station from the wide-area cell base station, estimate an interference from the wide-area cell to a terminal apparatus of a user located in the own cell, based on the null scheduling information, and determine a user scheduling related to an allocation of the terminal apparatus of the user on a time axis and a frequency axis, and communicate with the terminal apparatus of the user located in the own cell based on the user scheduling information.

Herein, in the user scheduling, the terrestrial cell base station may perform, an initialization process including a setting of a first set of user numbers u of terminal apparatuses of plural (N) unallocated users and setting a second set in order of resource numbers i for plural (N) radio resources processed by a greedy method, and a process for setting a k-th resource number k of the second set as a resource number i of a user allocation target in order of first (k=1) to N-th (k=N) of the resource numbers i of the second set, allocating a user number u of a terminal apparatus of a user, for which an estimated interference power is minimized when the radio resource of the resource number i is allocated, as a user number uᵢ to be allocated to the resource number i, and deleting the user number uᵢ for which an allocation is confirmed, from the first set.

In the foregoing system, each of the plural terrestrial cell base stations may perform a service link communication by a Frequency Division Duplex (FDD) method, the wide-area cell base station may obtain information related to plural terrestrial cell base stations located in the wide-area cell from a terrestrial cell base station database, determine, for each of the terrestrial cell base stations, a null scheduling regarding an allocation of nulls on a time axis and a frequency axis, based on the information related to the terrestrial cell base stations obtained from the terrestrial cell base station database, and transmit null scheduling information to each of the plural terrestrial cell base stations, and each of the plural terrestrial cell base stations may receive the null scheduling information related to the own station from the wide-area cell base station, estimate an interference from the wide area cell to terminal apparatuses of users located in the own cell, based on the null scheduling information, and determine a user scheduling related to an allocation of the terminal apparatus of the user on a time axis and a frequency axis, and communicate with the terminal apparatus of the user located in the own cell based on the user scheduling information.

Herein, in the user scheduling, the terrestrial cell base station may perform an initialization process including a setting of a first set of user numbers u of terminal apparatuses of plural (N) unallocated users and a setting of a second set in order of resource numbers i for plural (N) radio resources processed by a greedy method, and a process for setting a k-th resource number k of the second set as a resource number i of a user allocation target in order of first (k=1) to N-th (k=N) of the resource numbers i of the second set, allocating a user number u of a terminal apparatus of a user, for which an estimated interference power is minimized when the radio resource of the resource number i is allocated, as a user number uᵢ to be allocated to the resource number i, and deleting the user number uᵢ for which an allocation is confirmed, from the first set.

### Advantageous Effects of Invention

According to the present invention, it is possible to reduce a residual interference when forming a null of a directional beam from a relay communication station in an upper airspace which forms a wide area cell toward an antenna of a terrestrial cell base station.

### BRIEF DESCRIPTION OF DRAWINGS

FIG. 1 is a schematic configuration diagram showing an example of an overall configuration of a communication system including a HAPS according to an embodiment.

FIG. 2 is a perspective view showing an example of the HAPS of the embodiment.

FIG. 3 is a side view showing another example of the HAPS of the embodiment.

FIG. 4 is a perspective view showing an example of an array antenna of a service link of the HAPS of the embodiment.

FIG. 5 is a perspective view showing another example of an array antenna of a service link of the HAPS of the embodiment.

FIG. 6 is an illustration showing a problem when performing a beamforming in MU-MIMO using the array antenna of the HAPS.

FIG. 7 is an illustration showing an example of beamforming in MU-MIMO using the array antenna of the HAPS.

FIG. 8A is an illustration showing a null area that changes depending on the number of elements of the service link antenna of the HAPS.

FIG. 8B is an illustration showing a null area that changes depending on the number of elements of the service link antenna of the HAPS.

FIG. 9A is an illustration showing a null area that changes depending on the distance between the service link antenna of the HAPS and the terrestrial base station (antenna).

FIG. 9B is an illustration showing a null area that changes depending on the distance between the service link antenna of the HAPS and the terrestrial base station (antenna).

FIG. 10 is an illustration showing an occurrence status of residual interference in the case of the same directions (UL, DL) of service link communications that are synchronously performed in radio frames of a HAPS cell and terrestrial cells.

FIG. 11 is an illustration showing an occurrence status of residual interference in the case of a Time Division Duplex (TDD) method of different directions (UL, DL) of service link communications that are synchronously performed in radio frames of a HAPS cell and terrestrial cells.

FIG. 12 is an illustration showing an example of a null forming method applied when performing the FDD operation in the communication system of the embodiment.

FIG. 13 is an illustration showing an example of a null forming method applied when performing the TDD operation in the communication system of the embodiment.

FIG. 14A is an illustration showing an example of plural nulls formed toward the terrestrial cell in a first null forming method A-1 that can be selected and applied by the beamforming control from the relay communication station of the HAPS of the embodiment.

FIG. 14B is an illustration showing an example of switching the null sweeping on the time axis in the first null forming method A-1.

FIG. 15A is an illustration showing an application example of the null sweeping in the first null forming method A-1.

FIG. 15B is an illustration showing an application example of the null sweeping in the first null forming method A-1.

FIG. 15C is an illustration showing an application example of the null sweeping in the first null forming method A-1.

FIG. 16 is an illustration showing an example of plural nulls formed toward the terrestrial cells in a second null forming method A-2 that can be selected and applied by the beamforming control from the relay communication station of the HAPS of the embodiment.

FIG. 17A is an illustration showing an example of plural nulls formed toward the terrestrial cell in a third null forming method B-1 that can be selected and applied by the beamforming control from the relay communication station of the HAPS of the embodiment.

FIG. 17B is an illustration showing an example of switching the null sweeping on the time axis in the third null forming method B-1.

FIG. 18 is an illustration showing an example of plural nulls formed toward the terrestrial cells in a fourth null forming method B-2 that can be selected and applied by the beamforming control from the relay communication station of the HAPS of the embodiment.

FIG. 19A is an illustration showing an example of plural nulls formed toward the terrestrial cell in a fifth null forming method C-1 that can be selected and applied by the beamforming control from the relay communication station of the HAPS of the embodiment.

FIG. 19B is an illustration showing an example of switching the null sweeping on the time axis in the fifth null forming method C-1.

FIG. 20A is an illustration showing an application example of the multi-null sweeping in the fifth null forming method C-1.

FIG. 20B is an illustration showing an application example of the multi-null sweeping in the fifth null forming method C-1.

FIG. 21A is an illustration showing another example of plural nulls formed toward the terrestrial cell in the fifth null forming method C-1.

FIG. 21B is an illustration showing another example of switching the null sweeping on the time axis in the fifth null forming method C-1.

FIG. 22 is an illustration showing an example of plural nulls formed toward the terrestrial cells in a sixth null forming method C-2 that can be selected and applied by the beamforming control from the relay communication station of the HAPS of the embodiment.

FIG. 23 is an illustration showing an example of an overall configuration of a communication system having a terrestrial base station database according to the embodiment.

FIG. 24 is a block diagram showing an example of a main configuration of the relay communication station mounted in the HAPS in the communication system of FIG. 23.

FIG. 25 is a block diagram showing an example of a main configuration of a terrestrial cell base station in the communication system of FIG. 23.

FIG. 26 is a flowchart showing an example of a processing flow in a HAPS base station and the terrestrial cell base station when performing the beamforming control and the service link communication involving the null formation in the communication system according to the embodiment.

FIG. 27 is an illustration showing an example of a resource control algorithm that takes the null sweeping into consideration.

FIG. 28 is an illustration showing an example of setting resource number i, terrestrial base station user number u, and user number uᵢ allocated to resource number i in a user scheduling algorithm in the terrestrial cell base station when applying the resource control algorithm in FIG. 27.

FIG. 29 is an illustration showing an example of the user scheduling algorithm.

FIG. 30A is an illustration showing an example of the user (terminal apparatus) allocation to each resource by the user scheduling algorithm in FIG. 29.

FIG. 30B is an illustration showing an example of plural nulls formed toward the terrestrial cell when applying the user scheduling algorithm in FIG. 29.

FIG. 31A is an illustration showing an execution example of the user scheduling algorithm.

FIG. 31B is an illustration showing an execution example of the user scheduling algorithm.

### DESCRIPTION OF EMBODIMENTS

Hereinafter, embodiments of the present invention are described with reference to the drawings.

The system according to the embodiment described in the present specification is a communication system (HAPS system) provided with an upper airspace staying-type communication relay apparatus (HAPS), which is a flying body or floating body provided with a relay communication station of a wide-area cell base station (HAPS base station) that forms a cell facing on the ground or on the sea and can perform MU-MIMO communications with plural terminal apparatuses (UEs) located in the cell by using a multi-element array antenna. In the case that a terrestrial cell (second cell) formed by an existing terrestrial base station using the same frequency band is located in a HAPS cell (first cell) that is a wide-area cell, the foregoing communication system (HAPS system) can reduce a residual interference when forming a null of a directional beam from a relay communication station of the HAPS toward the antenna of the terrestrial cell base station to suppress an interference. The communication system according to the present embodiment is suitable for realizing a three-dimensional network for the next-generation mobile communications such as the fifth generation, etc., which supports simultaneous connections to a large number of terminal apparatuses and low latency.

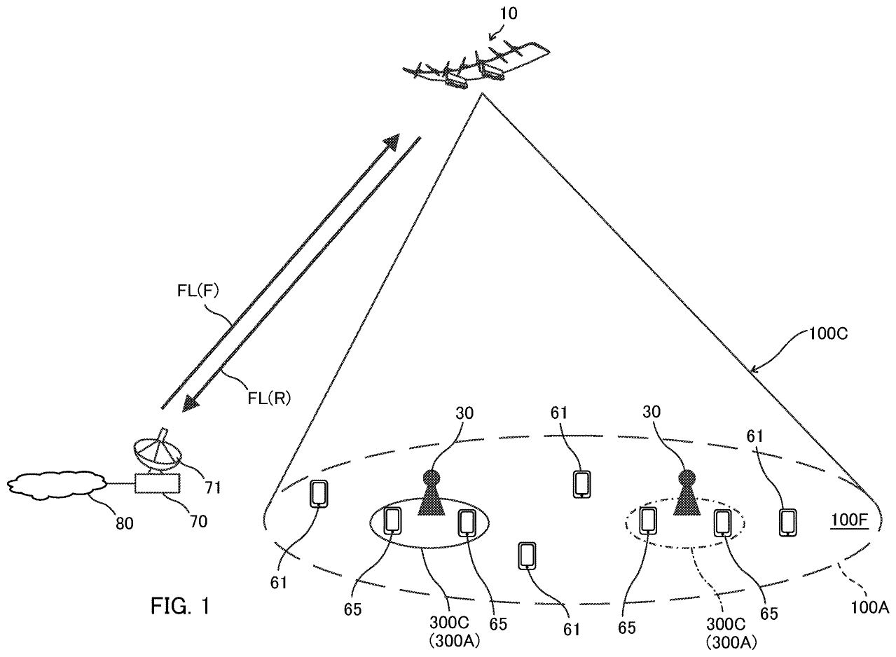

FIG. 1 is a schematic configuration diagram showing an example of an overall configuration of a communication system including a HAPS (upper airspace staying-type communication relay apparatus) according to an embodiment. In FIG. 1, the HAPS system configuring the communication system of the present embodiment is provided with a high-altitude platform station (HAPS) (also called a “high-altitude pseudo satellite” or “stratospheric platform”) 10 as an upper airspace staying-type communication relay apparatus (radio relay apparatus) that is a flying body or floating body equipped with a relay communication station. The HAPS 10 is located in an airspace at a predetermined altitude and forms a three-dimensional cell (hereinafter also referred to as a “HAPS cell”) 100C as a wide-area cell (first cell). The HAPS 10 is a flying body or floating body (for example, a solar plane, airship, drone, balloon) that is controlled to float or fly in an airspace (floating airspace) at a predetermined altitude above the ground or the sea level by an autonomous control or an external control, and has a relay communication station mounted in it. It is noted that the foregoing communication relay apparatus of upper airspace staying-type may be an artificial satellite such as a low earth orbit (LEO) satellite or a geostationary orbit (GEO) satellite, etc., which is equipped with a relay communication apparatus. Furthermore, the communication system of the present embodiment may include one or plural terminal apparatuses with which the HAPS 10 communicates, and may also include a gateway station (feeder station) to be described later.

The airspace in which the HAPS 10 is located is, for example, a stratospheric airspace with altitude of 11 [km] or more and 50 [km] or less on the ground (or on the water such as the sea or lake). This airspace may be an airspace with altitude of 15 [km] or more and 25 [km] or less where weather conditions are relatively stable, and may be an airspace with altitude of about 20 [km] in particular.

Since the HAPS locates lower than the flight altitude of general artificial satellites and flies in the airspace with altitude higher than base stations on the ground or on the sea, the HAPS can ensure high visibility while experiencing smaller propagation loss than satellite communications. This feature makes it possible to provide communication services from the HAPS to a terminal apparatus (mobile station) 61 that is a user apparatus such as a cellular mobile terminal, etc. on the ground or on the sea. By providing the communication services from the HAPS, a wide area, which is previously covered by a large number of base stations on the ground or on the sea, can be covered with a small number of HAPSs, it is capable of having the advantage of providing stable communication services at low cost.

The relay communication station of the HAPS 10 forms a HAPS cell 100C capable of performing a radio communication with the UE 61, by forming a beam for radio communication with a user's terminal equipment (hereinafter referred to as “UE” (user equipment)) toward the ground surface (or the sea surface). The radius of a service area (also called a “HAPS service area”) 100A consisting of a footprint 100F on the ground (or on the sea) of this HAPS cell 100C is, for example, several tens of kilometers to 100 kilometers.

It is noted that, in the present embodiment, the relay communication station of the HAPS 10 may form plural three-dimensional cells (for example, three cells or seven cells) and form the service area 100A consisting of plural footprints on the ground (or the sea) of the plural three-dimensional cells.

The communication system of the present embodiment is an environment of mixture of the HAPS 10 equipped with an upper-airspace relay communication station that constitutes a wide-area cell base station (hereinafter also referred to as a “HAPS base station”) and a low-positioned base station (hereinafter referred to as a “terrestrial cell base station” or “terrestrial base station”) 30 which forms a cell that is an interference suppression target located on the ground or on the sea. In the example of FIG. 1, plural antennas of the low-positioned terrestrial base stations 30 (hereinafter also referred to as “base station antennas”) are located inside the HAPS cell 100C, and a cell (hereinafter referred to as “terrestrial cell”) 300C of the terrestrial base station 30 is formed, which is smaller than the footprint 100F of the cell 100C, inside the service area 100A consisting of the footprint 100F of the three-dimensional cell 100C.

The wide-area cell base station including the relay communication station mounted in the HAPS 10 and the terrestrial base station (for example, eNodeB, gNodeB) 30 respectively uses time-synchronized radio frames with each other and the same frequency band for performing the radio communications of service links with the UEs 61 and 65 located in the own cells 100C and 300C. The terrestrial base station 30 may be configured such that an RRH (Remote Radio Head) having a base station antenna and a BBU (Base Band Unit), which are connected to each other via an optical line. In this case, the RRH having the base station antenna is located at the location of the base station 30 in FIG. 1.

The relay communication station mounted in the HAPS 10 is, for example, a base station (for example, eNodeB, gNodeB) that wirelessly communicates with a gateway station (also called a “feeder station”) 70, which serves as a relay station connected to a core network of a mobile communication network 80 on the ground (or on the sea) side and has an antenna 71 facing toward the upper airspace. The relay communication station of the HAPS 10 is connected to the core network of the mobile communication network 80 via the feeder station 70 disposed on the ground or on the sea. The communication between the HAPS 10 and the feeder station 70 may be performed by radio communication using radio waves such as microwaves, or by optical communication using laser light or the like.

The relay communication station (also called “radio relay station”) mounted in the HAPS 10 may be a repeater-type relay communication station, or may be a base station apparatus-type relay communication station. The repeater-type relay communication station configures the wide-area cell base station in combination with the base station apparatus mounted in the feeder station 70. The base station apparatus-type relay communication station functions as the wide-area cell base station.

The repeater-type relay communication station includes, for example, a repeater and a frequency conversion apparatus. The repeater includes a low noise amplifier that amplifies a reception signal of service link received via a service link antenna, a power amplifier that amplifies a transmission signal to be transmitted via the service link antenna, and the like. The frequency conversion apparatus converts between the service link frequency and the feeder link frequency. The feeder station 70 includes, for example, the base station apparatus and the frequency conversion apparatus. The base station apparatus includes a baseband processing apparatus for processing baseband signals of the service link, a communication interface section for communicating with the core network via a backhaul line, and the like. The frequency conversion apparatus converts between the frequency of the service link signal input/output to/from the base station apparatus and the frequency of the feeder link signal.

The base station apparatus-type relay communication station includes, for example, the base station apparatus and a feeder link transceiver. The base station apparatus includes the low noise amplifier that amplifies the reception signal of the service link, a power amplifier that amplifies the transmission signal to be transmitted via the service link antenna, a baseband processing apparatus for processing baseband signals of the service link, and the like. The feeder link transceiver transmits and receives signals of the backhaul line transmitted and received between the feeder station 70. The feeder station 70 transmits and receives signals of the backhaul line transmitted and received between the relay communication station in the upper airspace.

The HAPS 10 may autonomously control its own floating movement (flight) and a process in the relay communication station by executing a control program by a control section configured with a computer, etc. built in the inside. For example, each of the HAPSs 10 may acquire its own current position information (for example, GPS position information), position control information (for example, flight schedule information) stored in advance, position information on another HAPS located in a peripheral space, or the like, and may autonomously control the floating movement (flight) and the process in the relay communication station based on these kins of information.

Further, the floating movement (flight) of the HAPS 10 and the process in the relay communication station may be possible to control by a management apparatus (also referred to as a “remote control apparatus”) as a management apparatus provided in a communication center or the like of the mobile communication network 80. The management apparatus can be configured with, for example, a computer apparatus such as a PC, a server, or the like. In this case, the HAPS 10 may incorporate a communication terminal apparatus for control (for example, mobile communication module) so that it can receive control information from the management apparatus and transmit various kinds of information such as monitoring information to the management apparatus, and may be allocated terminal identification information (for example, IP address, phone number, etc.) so that it can be identified from the management apparatus. The MAC address of the communication interface may be used to identify the communication terminal apparatus for control. Furthermore, the HAPS 10 may transmit information on the floating movement (flight) of the HAPS itself or its surroundings and the process at the relay communication station, and monitoring information such as information on the status of the HAPS 10 and observation data acquired by various kinds of sensors, to a predetermined destination such as the management apparatus, etc. The control information may include information on the target flight route of the HAPS. The monitoring information may include at least one of information on current position, flight-route history information, velocity relative to the air, velocity relative to the ground and propulsion direction of the HAPS 10, wind velocity and wind direction of airflow around the HAPS 10, and atmospheric pressure and temperature around the HAPS 10.

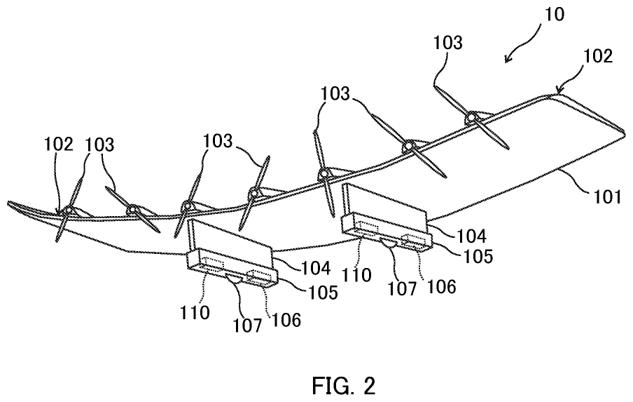

FIG. 2 is a perspective view showing an example of the HAPS 10 used in the communication system of the embodiment.

The HAPS 10 in FIG. 2 is a solar plane-type HAPS, and is provided with a main wing section 101 with both end edge sections curved upwards in the longitudinal direction, and plural motor-driven propellers 103 as propulsion apparatuses for a bus power system at one end edge section in the short side direction of the main wing section 101. A solar-power generation panel (hereinafter referred to as “solar panel”) 102 as a solar-power generation section having a solar-power generation function is provided on the upper surface of the main wing section 101. Further, pods 105 as plural equipment accommodating sections for accommodating mission equipment are connected to two locations in the longitudinal direction of the lower surface of the main wing section 101 via plate-shaped connecting sections 104. Inside each pod 105, a relay communication station 110 as a mission equipment and a battery 106 are housed. Furthermore, a wheel 107 used for takeoff and landing is provided on the lower surface side of each pod 105. The electric power generated by the solar panel 102 is stored in the battery 106, and the motors of propellers 103 are rotationally driven and the radio relay process by the relay communication station 110 is executed, by the electric power supplied from the battery 106.

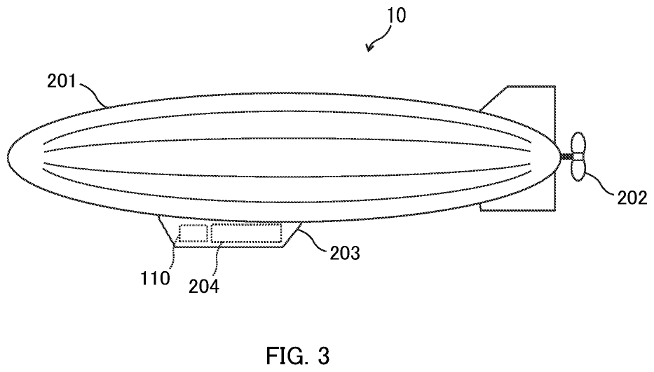

FIG. 3 is a perspective view showing another example of the HAPS 10 used in the communication system of the embodiment. The HAPS 10 in FIG. 3 is an unmanned airship-type HAPS and can be equipped with a large capacity battery because of its large payload. The HAPS 10 is provided with an airship main body 201 filled with a gas such as helium gas, etc. for floating by buoyancy, a motor-driven propeller 202 as a propulsion apparatus for a bus power system, and an equipment accommodating section 203 for accommodating mission equipment. Inside the equipment accommodating section 203, the relay communication station 110 and a battery 204 are housed. The motor of the propeller 202 is rotationally driven and the radio relay process by the relay communication station 110 is executed, by the electric power supplied from the battery 204. It is noted that a solar panel having a solar-power generation function may be provided on the upper surface of the airship main body 201, and the electric power generated by the solar panel may be stored in the battery 204.

It is noted that in the following embodiment, although the upper airspace staying-type communication relay apparatus that wirelessly communicates with the UE 61 is illustrated and described with respect to either the solar plane-type HAPS 10 or the unmanned airship-type HAPS 20 in FIG. 2, the upper airspace staying-type communication relay apparatus may also be the unmanned airship-type HAPS 10 in FIG. 3. Moreover, the following embodiment can be similarly applied to other upper airspace staying-type communication relay apparatuses other than the HAPS 10.

Moreover, links FL(F) and FL(R) between the HAPS 10 and the gateway station (hereinafter abbreviated as “GW station”) 70 serving as a feeder station are called “feeder links”, and a link between the HAPS 10 and the UE 61 is called “service link”. In particular, the section between the HAPS 10 and the GW station 70 is called the “radio section of feeder link”. In addition, the downlink of communication from the GW station 70 to the UE 61 via the HAPS 10 is also called the “forward link” FL(F), and the uplink of communication from the UE 61 to the GW station 70 via the HAPS 10 is also called the “reverse link” FL(R).

In the communication system of the present embodiment, the duplexing method for the uplink and downlink of the radio communication between the terrestrial base station 30 and the UE 65 is not limited to a specific method, and may be, for example, a Time Division Duplex (TDD) method or a Frequency Division Duplex (FDD) method. In addition, the access method for radio communication between the terrestrial base station 30 and the UE 65 is not limited to a specific method, and may be, for example, an FDMA (Frequency Division Multiple Access) method, a TDMA (Time Division Multiple Access) method, a CDMA (Code Division Multiple Access) method, or an OFDMA (Orthogonal Frequency Division Multiple Access) method.

Similarly, the duplexing method of the uplink and downlink of the radio communication with the UE 61 via the relay communication station 110 is not limited to a specific method, and may be, for example, the Time Division Duplexing (TDD) method or the Frequency Division Duplexing (FDD) method. Further, the access method for radio communication with the UE 61 via the relay communication station 110 is not limited to a specific method, and may be, for example, the FDMA method, the TDMA method, the CDMA method, or the OFDMA method.

In addition, the radio communication of the service link in the present embodiment uses a massive MIMO (Multiple-Input Multiple-Output) transmission method that has functions such as diversity coding, transmission beamforming and Spatial Division Multiplexing (SDM), etc., and performs multi-layer transmission using an array antenna having a large number of antenna elements. In particular, in the present embodiment, in the downlink communication from the relay communication station of the HAPS 10 to plural UEs 61 within the cell, a MU-MIMO (Multi-User MIMO) technology is used, which transmits signals to plural different UEs 61 at the same time and with the same frequency. By performing the MU-MIMO transmission using an array antenna having a large number of antenna elements, the communication can be performed by directing an appropriate beam to each UE 61 according to the communication environment of each UE 61, thereby improving the communication quality of the entire cell. Furthermore, since the communications with plural UEs 61 can be performed using the same radio resources (time and frequency resources), the system capacity can be expanded.

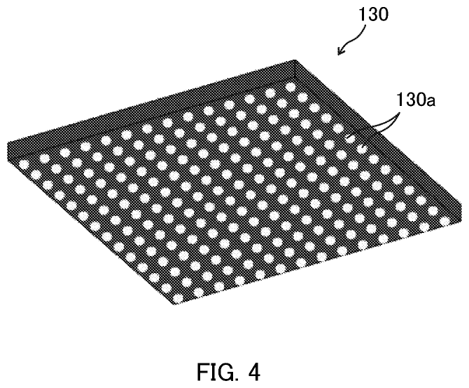

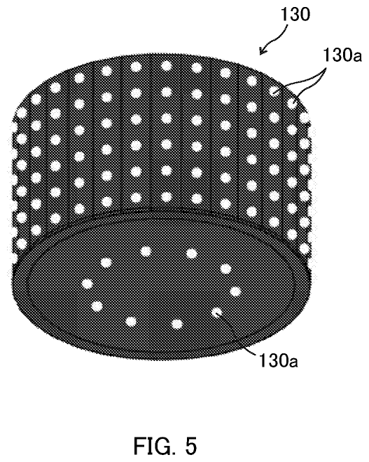

Each of FIGS. 4 and 5 is a perspective view showing an example of an array antenna 130 configured with multi-element that can be used in the MU-MIMO transmission method in the HAPS 10 of the present embodiment.

The array antenna 130 in FIG. 4 is a planar-type array antenna having a flat board-formed antenna base, in which a large number of antenna elements 130a such as patch antennas are disposed two-dimensionally in axial directions perpendicular to each other along the planar antenna surface of the antenna base.

The array antenna 130 in FIG. 5 is a cylinder-type array antenna having a cylindrical or columnar antenna base, in which a large number of antenna elements 130a such as patch antennas are disposed along each of the axial and circumferential directions of the circumferential side surface serving as a first antenna surface of the antenna base. In the array antenna 130 of FIG. 5, as shown in the figure, plural antenna elements 130a such as patch antennas may be disposed in a circular shape along the bottom surface serving as the second antenna surface. Furthermore, the antenna base in FIG. 5 may be an antenna base having a polygonal tube shape or a polygonal circular-column shape.

It is noted that the shape of array antenna 130 and the number, type and placement of antenna elements are not limited to those exemplified in FIGS. 4 and 5.

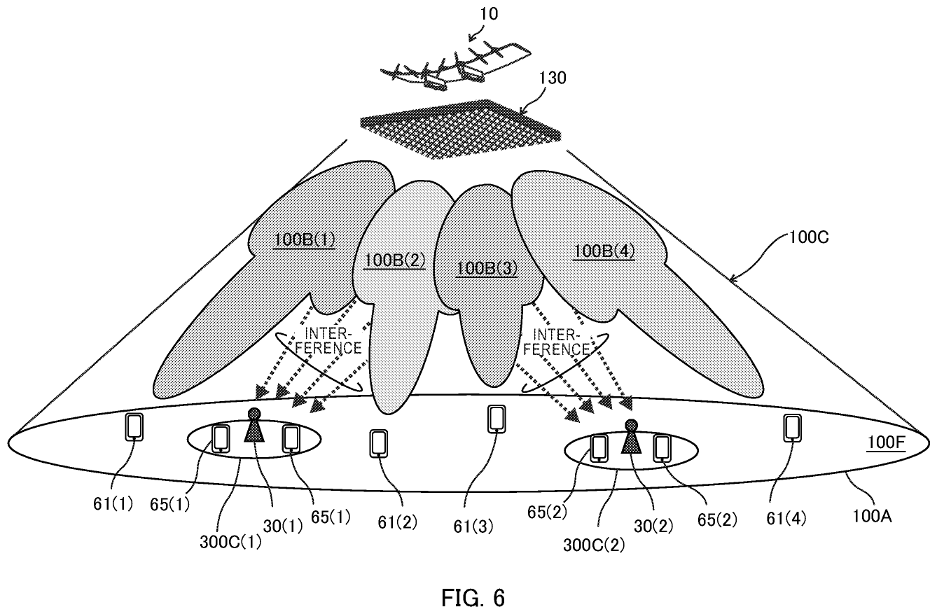

FIG. 6 is an illustration showing a problem when performing a beamforming in the MU-MIMO transmission method using the array antenna 130 of the HAPS 10. In the service link SL between the array antenna 130 of the HAPS 10 and the service area 100A (footprint 100F of cell 100C) in FIG. 6, by using the MU-MIMO transmission method and performing a beamforming which directs appropriate high-gain beams 100B(1) to 100B(4) to each of the UEs 61(1) to 61(4) individually in accordance with the communication environment of each UE 61, compensates for long-distance propagation loss and communicates with the UEs, communication quality can be improved. In particular, in the case of using the MU-MIMO transmission method in which the same radio resource (for example, the same time/frequency resource block (RB)) is used to communicate with plural UEs 61 in the service link SL, the system capacity can be improved.

However, in the environment of mixture of the HAPS 10 and the terrestrial base stations 30(1) and 30(2) as shown in FIG. 6, when the HAPS 10 and the terrestrial base stations 30(1) and 30(2) use the same frequency band to simultaneously communicate with UEs 61 and 65 located in each cell, the downlink radio transmission signal transmitted from the HAPS 10 may cause interference with service link communications (hereinafter also referred to as “terrestrial system communications”) between the terrestrial base stations 30(1) and 30(2) and UEs 65(1) and 65(2) located in the terrestrial cells 300C(1) and 300C(2). When the interference from the HAPS 10 occurs, the throughput of communication between the terrestrial base stations 30(1) and 30(2) and the UE 65 drops significantly.

In the present embodiment, a beamforming control of the HAPS cell is performed so that a null of a beam pattern (profile of the spatial distribution of the beam) is directed toward the terrestrial base station (antenna) located within the HAPS cell, based on the position information of the base station antenna of the terrestrial base station, in the HAPS 10. This beamforming control suppresses the interference given by the HAPS 10 to communications in the terrestrial system without causing a significant decrease in communication quality in which a desired signal is transmitted by multiple beams to each of the plural UEs 61 located in the HAPS cell.

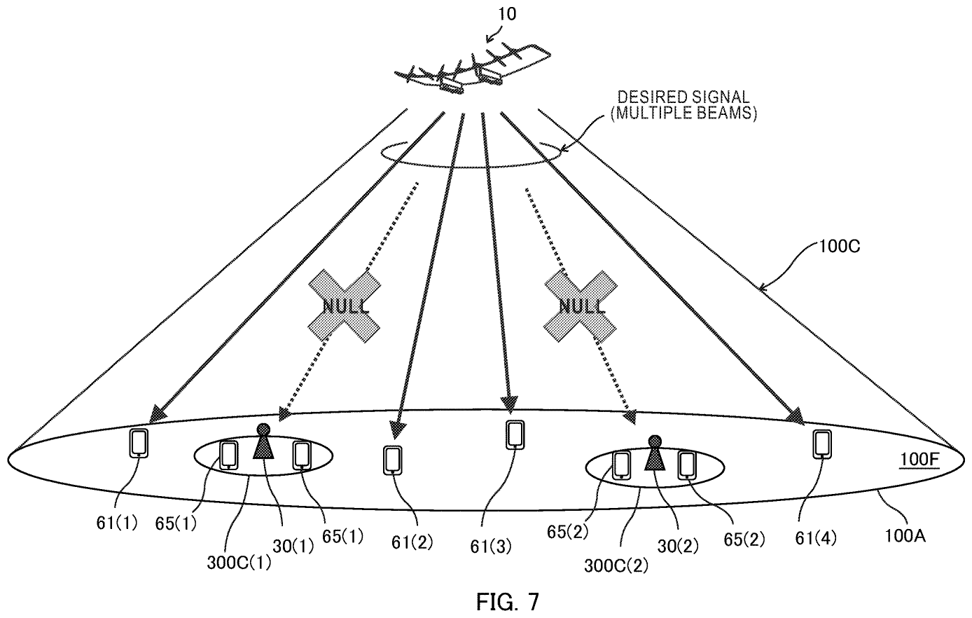

FIG. 7 is an illustration showing an example of beamforming in the MU-MIMO using the array antenna of the HAPS according to the embodiment. In the example of FIG. 7, a beamforming control is performed on the HAPS 10 side so that the null of the beam pattern (profile of the spatial distribution of the beam) is directed toward each of the plural terrestrial base stations (antennas) 30(1) and 30(2) located in the HAPS cell 100C. Since this makes it possible to suppress, on the transmission side, the interference given by the HAPS 10 to the communication of the terrestrial system of each of the terrestrial base stations (antennas) 30(1) and 30(2), the terrestrial base stations 30(1) and 30(2) and the UEs 65(1) and 65(2) in the terrestrial cells 300C(1) and 300C(2) can communicate normally. In addition, since the multiple beams for transmitting desired signals to each of the plural UEs 61(1) to 61(4) located in the HAPS cell are maintained, a significant decrease in communication quality of downlink communications from the HAPS 10 to the plural UEs 61(1) to 61(4) does not occur.

[Residual Interference when Forming the Null]

It is described herein of a residual interference in the case of directing and forming the null of the beam pattern (profile of spatial distribution of a beam) toward each of the terrestrial base stations (antennas) 30 from the HAPS 10. As shown below, the occurrence of this residual interference is affected by a size relationship between an area range (hereinafter referred to as the “null area”) in which an interference can be avoided with a single null and the terrestrial cell 300C of the terrestrial base station 30 to which the null is directed, and also affected by the conditions of the uplink (UL) and downlink (DL) in the communication direction of the service link communication that is synchronously performed in the radio frames of the HAPS cell 100C and the terrestrial cell 300C.

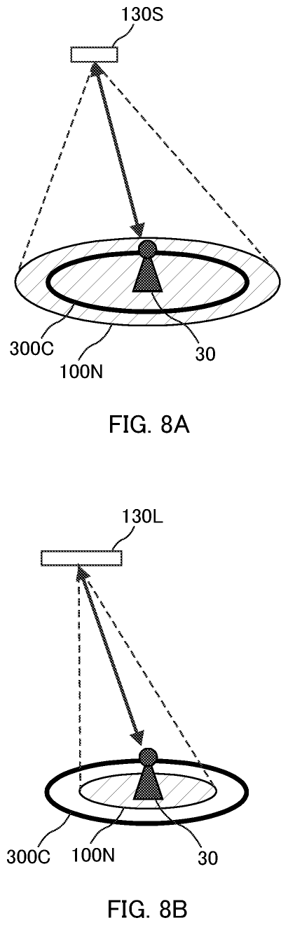

FIGS. 8A and 8B are illustrations showing the null area that changes depending on the number of elements of the service link antenna 130 of the HAPS 10. In the case that the service link antenna 130 is an antenna with a large number of elements and high gain such as a massive MIMO antenna, etc., the null area 100N in which the interference can be avoided with a single null becomes narrow. For example, as shown in FIG. 8A, in the case that a small-scale array antenna 130S with a small number of elements is used as a service link antenna and the null area 100N is wider than the area of the terrestrial cell 300C that is the area range of the terrestrial cell 300C, the residual interference from the HAPS 10 is small throughout the entire area of the terrestrial cell 300C. On the other hand, as shown in FIG. 8B, in the case that a large-scale array antenna 130L with a large number of elements is used as a service link antenna and the null area 100N is narrower than the area of the terrestrial cell 300C, the residual interference from the HAPS 10 is large at the cell edge of the terrestrial cell 300C.

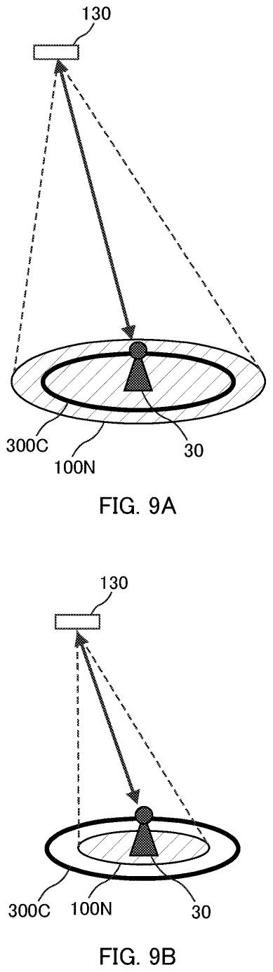

FIGS. 9A and 9B are illustrations showing the null area that changes depending on the distance between the service link antenna 130 of the HAPS 10 and the terrestrial base station (antenna) 30. The lower altitude the HAPS 10 flies, the narrower the null area 100N when directing the single null. For example, as shown in FIG. 9A, in the case that the distance between the HAPS 10 and the terrestrial base station (antenna) 30 is long and the null area 100N is wider than the area of the terrestrial cell 300C which is the area range of the terrestrial cell 300C, the residual interference from the HAPS 10 is small throughout the entire area of the terrestrial cell 300C. On the other hand, as shown in FIG. 9B, in the case that the distance between the HAPS 10 and the terrestrial base station (antenna) 30 is short and the null area 100N is narrower than the area of the terrestrial cell 300C, the residual interference from the HAPS 10 becomes large at the cell edge of the terrestrial cell 300C.

As shown in FIGS. 8B and 9B, in the case that the null area 100N is narrower than the area of the terrestrial cell 300C, the further away from the center of the terrestrial cell 300C, the larger the residual interference from the HAPS 10 that cannot be completely suppressed.

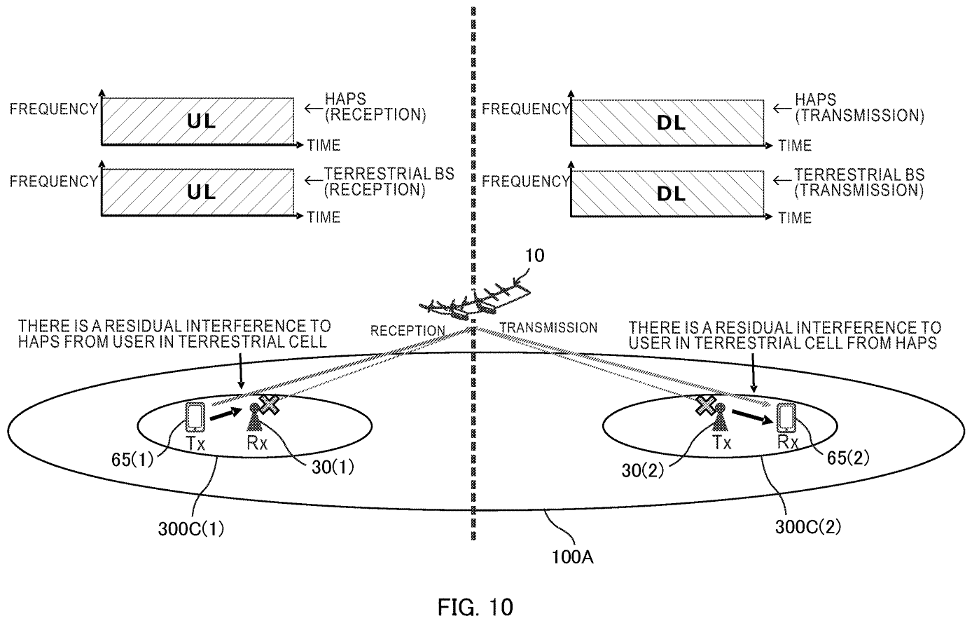

FIG. 10 is an illustration showing an occurrence status of the residual interference in the same directions (UL, DL) of service link communications that are synchronously performed in the radio frames of the HAPS cell 100C and the terrestrial cells 300C. In the example of FIG. 10, the FDD (Frequency Division Duplex) method is used in each of the HAPS cell 100C and the terrestrial cells 300C, and the single null is formed from the HAPS 10 toward the terrestrial base stations (antennas) 30. For example, as shown in the left half portion of FIG. 10, in the case that the uplink (UL) communication is performed in each of the HAPS cell 100C and the terrestrial cell 300C, the residual interference occurs to the HAPS 10 from the UE 65(1) of the user located in the terrestrial cell. As shown in the right half portion of FIG. 10, in the case that the downlink (DL) communication is performed in each of the HAPS cell 100C and the terrestrial cell 300C, the residual interference occurs from the HAPS 10 to the UE 65(2) of the user located in the terrestrial cell. In this way, since the residual interference occurs when the single null is formed from the HAPS 10 toward the terrestrial base station (antenna) 30, a measure is needed to reduce these residual interferences. For this measure, the present embodiment applies a new interference reduction method, as described below.

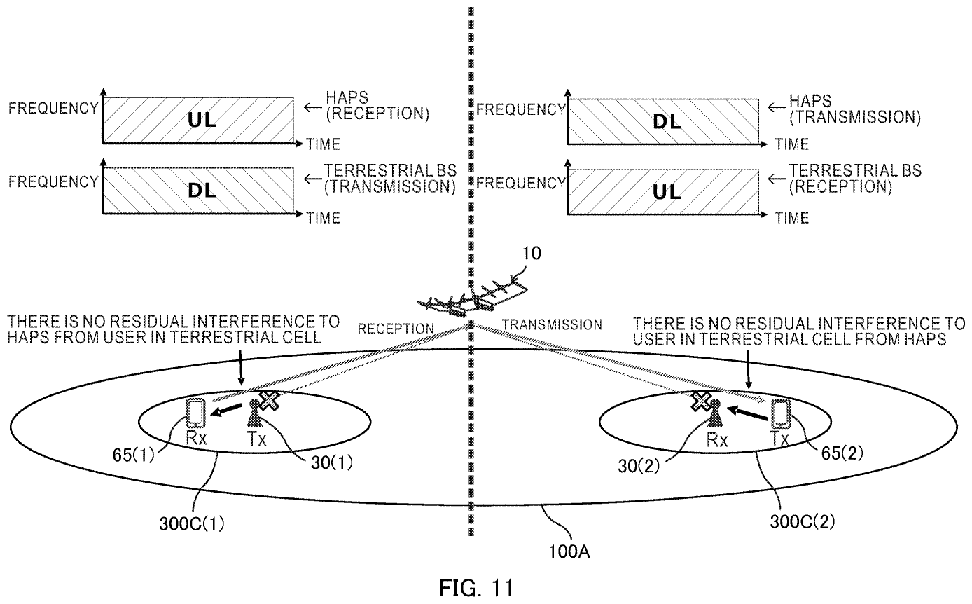

FIG. 11 is an illustration showing an occurrence status of the residual interference in the case that the directions (UL, DL) of service link communications are different from each other, which are synchronously performed in the radio frames of the HAPS cell 100C and the terrestrial cells 300C. In the example of FIG. 11, each of the HAPS cell 100C and the terrestrial cells 300C uses the TDD (Time Division Duplex) method, and the single null is formed from the HAPS 10 toward the terrestrial base stations (antennas) 30. For example, as shown in the left half portion of FIG. 11, in the case that the uplink (UL) communication is performed in the HAPS cell 100C and the downlink (DL) communication is performed in the terrestrial cells 300C, there is no residual interference from the terrestrial cell base stations 30 to the HAPS 10. As shown in the right half portion of FIG. 11, in the case that the downlink (DL) communication is performed in the HAPS cell 100C and the uplink (DL) communication is performed in the terrestrial cells 300C, there is no residual interference from the HAPS 10 to the terrestrial cell base station 30. In this way, by forming the single null from the HAPS 10 toward the terrestrial base stations (antennas) 30, the interference can be completely suppressed and no residual interference occurs, so no measure to reduce the residual interference is required, and no special new interference reduction method is required.

In order to reduce the residual interference, the HAPS base station (wide-area cell base station), which is provided with the relay communication station 110 mounted in the HAPS 10, selects and determines a null forming method used in the beamforming control from among plural types of null forming methods depending on the conditions of the uplink (UL) and downlink (DL) of service link communications that are synchronously performed in the radio frames of the HAPS cell 100C and the terrestrial cell 300C. More specifically, the HAPS base station switches, for plural terrestrial base stations 30, the null forming method such as the following (1) and (2) depending on the UL/DL conditions of the own station and the terrestrial base stations.
(1) The UL/DL resources are different for the HAPS 10 and the terrestrial base station 30 (the case of FIG. 11 described above): the single null is formed in the direction of the terrestrial base station antenna.
(2) The UL/DL resources are the same for the HAPS 10 and the terrestrial base station 30 (the case of FIG. 10 described above): any one of the plural types of null forming methods A-1, A-2, B-1, B-2, C-1 and C-2 described below is applied.

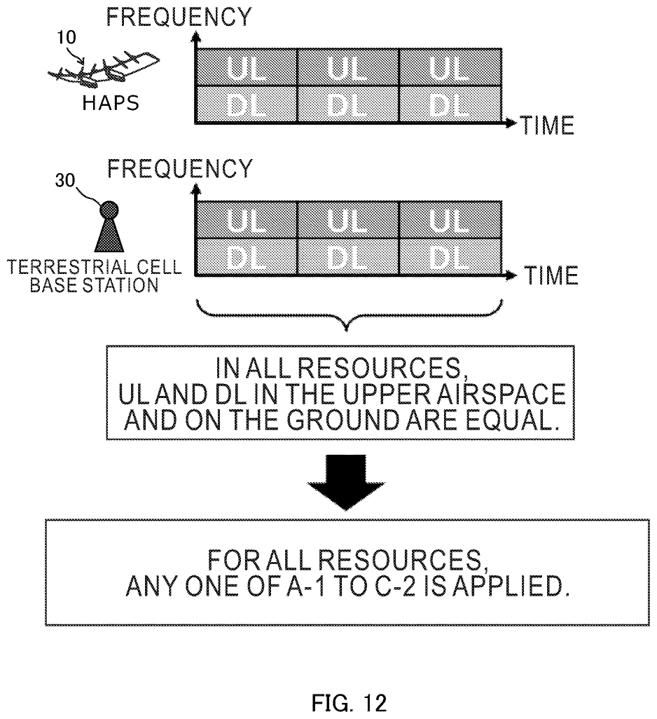

FIG. 12 is an illustration showing an example of a null forming method applied when performing the FDD operation in the communication system of the embodiment. In the example when performing the FDD operation in FIG. 12, the communication directions (UL/DL) of the service links of the HAPS 10 and the terrestrial cell base station 30 are the same in all resources, thereby, for all resources, any one of the null forming methods A-1, A-2, B-1, B-2, C-1 and C-2 is applied.

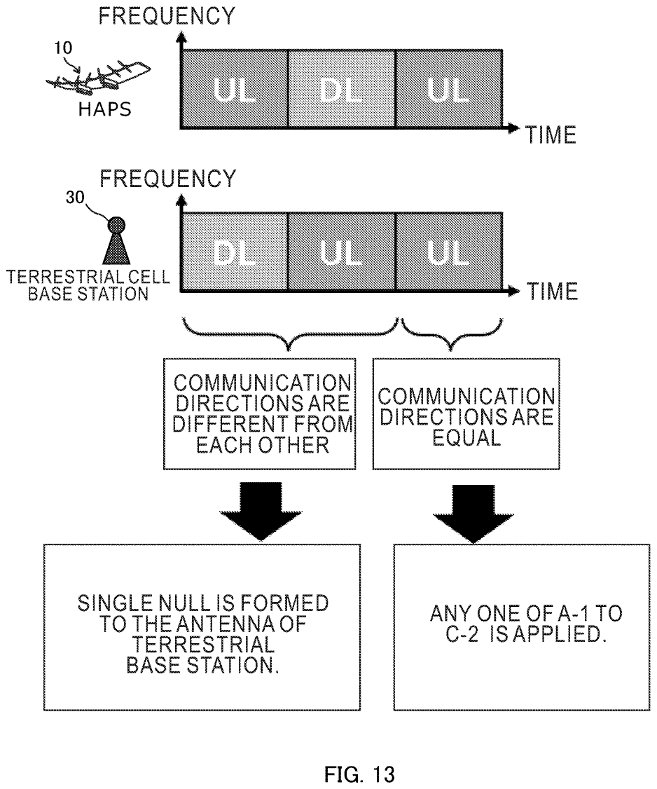

FIG. 13 is an illustration showing an example of a null forming method applied when performing the TDD operation in the communication system of the embodiment. In the example when performing the TDD operation in FIG. 13, for resources in which the communication directions (UL/DL) of the service links of the HAPS 10 and the terrestrial cell base station 30 are different from each other, the single null is formed toward the antenna of the terrestrial cell base station 30. In addition, for resources in which the communication directions (UL/DL) of the service links of the HAPS 10 and the terrestrial base station 30 are the same, any one of the null forming methods A-1, A-2, B-1, B-2, C-1 and C-2 is applied.

### [Null Forming Method A-1]

As described above, in the case that the single null directed toward the antenna of the terrestrial base station 30 is used, the influence of residual interference, which cannot be completely suppressed, increases with distance from the center of the terrestrial cell. The first null forming method A-1 is a null forming method suitable for reducing such residual interference.

The null forming method A-1 is a null sweeping method, in which one null is selected per radio resource (time/frequency resource) from among plural null candidates with directions different from each other, and the direction of the null is switched on a time axis, on a frequency axis, or on both axes, when directing a null from the HAPS 10 in the direction of the terrestrial cell 300C.

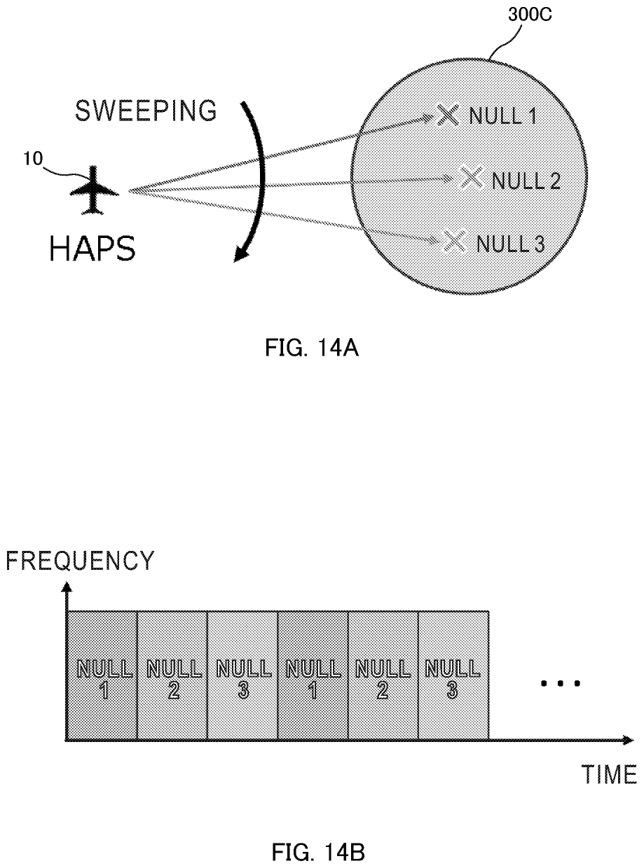

For example, in the examples of FIGS. 14A and 14B, there are three null candidates 1, 2 and 3 that have different directions, and when directing a null from the HAPS 10 in the direction of the terrestrial cell 300C, one null is selected from the three null candidates 1, 2 and 3 per radio resource (time/frequency resource), and the direction of the null is switched on the time axis.

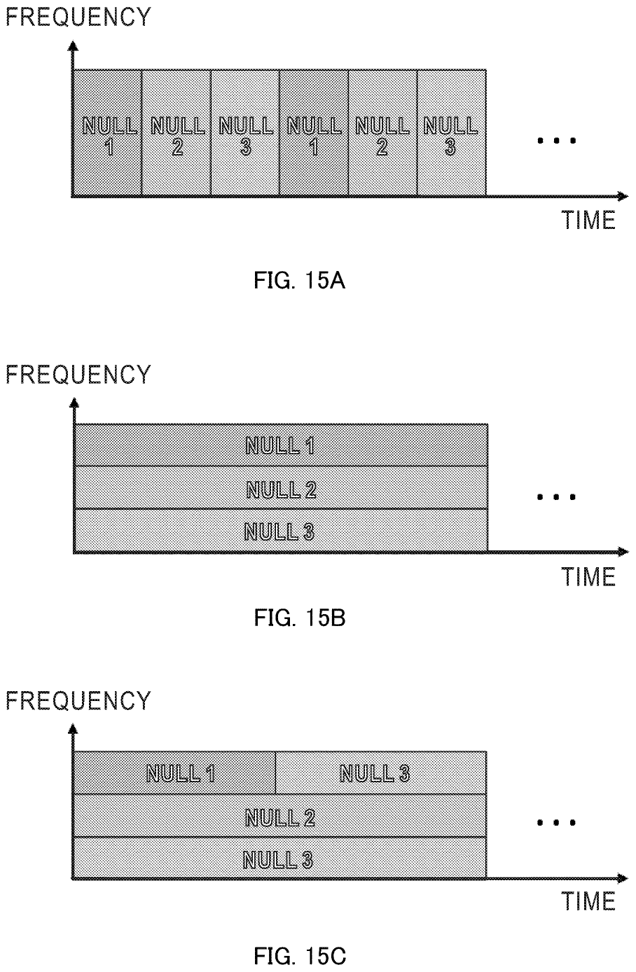

Each of FIGS. 15A, 15B, and 15C is an illustration showing an application example of the null sweeping in the first null forming method A-1. In the example of FIG. 15A, the directions of the nulls 1, 2 and 3, which are selected on a radio resource basis, are switched on the time axis. In the example of FIG. 15B, the directions of the nulls 1, 2 and 3, which are selected on a radio resource basis, are switched on the frequency axis. In the example of FIG. 15C, the directions of the nulls 1, 2 and 3, which are selected on a radio resource basis, are switched on both the time axis and the frequency axis.

It is noted that, in the example of the null forming method A-1, although the number of nulls per radio resource (time/frequency resource) is set to 1, the percentage of nulls occupying in the radio resources (time/frequency resources) may be changed depending on the user distribution in the terrestrial cell 300C.

According to the null forming method A-1, by performing a user scheduling taking the null sweeping into consideration in each terrestrial base station 30, the influence of residual interference can be minimized and the capacity of each terrestrial cell 300C can be improved.

### [Null Forming Method A-2]

When performing the null sweeping, the number of optimal null candidates and their directions are different for each terrestrial cell 300C. The second null forming method A-2 is a null sweeping method suitable for the case where the number and directions of such optimal null candidates are different for each terrestrial cell 300C.

The null forming method A-2 is a method for changing at least one of the number and direction of null candidates to be swept for each terrestrial cell 300C in the null sweeping of the null forming method A-1. For example, the null forming method A-2 may be a method in which at least one of the number and direction of null candidates is changed based on at least one of the following A-2(1) to A-2(3).
A-2(1): Distance between the HAPS 10 and the terrestrial cell 300C.
A-2(2): User distribution in the terrestrial cell 300C.
A-2(3): Shape of the terrestrial cell 300C.

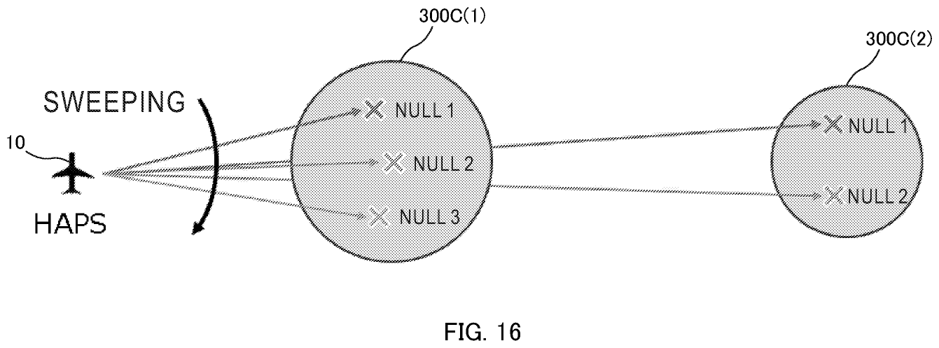

For example, the example in FIG. 16 is an example in which the number of null candidates to be swept is changed according to the distance between the HAPS and the terrestrial cell. In the example of FIG. 16, the number of null candidates for the terrestrial cell 300C(1) close to the HAPS 10 is three, and the number of null candidates for the terrestrial cell 300C(2) far from the HAPS 10 is two.

According to the null forming method A-2, the performance of the terrestrial cell 300C is improved by adaptively controlling the number and direction of null candidates for each terrestrial cell 300C. Furthermore, by not unnecessarily increasing the number of null candidates, the processing load on the HAPS 10 and the terrestrial base station 30 can be kept to a minimum.

### [Null Forming Method B-1]

Depending on the configuration (half-width and spacing of the elements, etc.) of the array antenna mounted on the HAPS 10 as a service link antenna, the width of the null may become extremely narrow, and even if the null direction is shifted slightly due to movement or rotation of the body of the HAPS 10, the interference reduction effect may be significantly degraded. The third null forming method B-1 is a null forming method suitable for the cases where the interference reduction effect deteriorates due to such the movement or rotation of the body of the HAPS 10.

The null forming method B-1 is a multi-null forming method, in which two or more nulls with different directions are simultaneously formed for each terrestrial cell 300C, when directing the nulls from the HAPS 10 toward the terrestrial cell 300C.

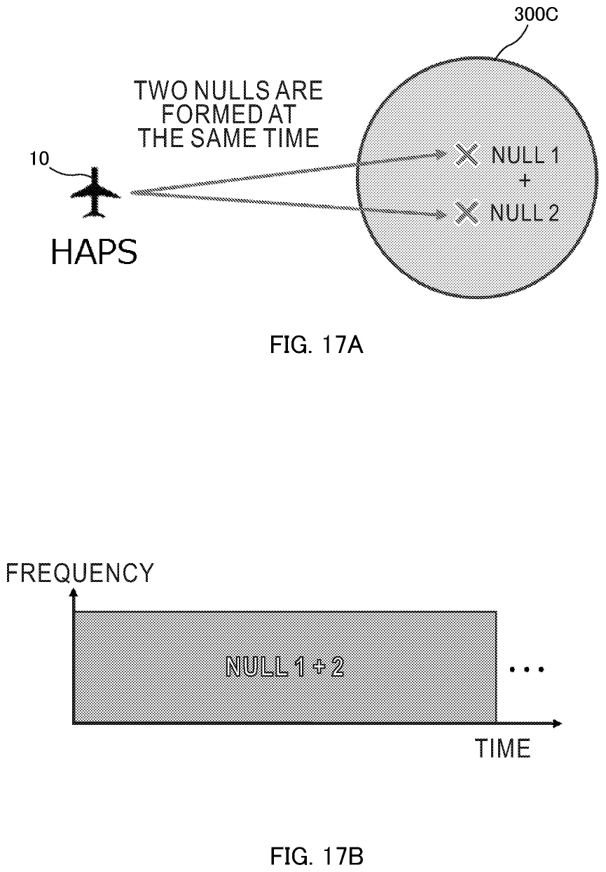

For example, in the examples of FIGS. 17A and 17B, two nulls 1 and 2 in different directions are formed at the same time toward the terrestrial cell 300C using one radio resource (time/frequency resource).

According to the null forming method B-1, by forming the plural nulls at the same time for each terrestrial cell 300C, the width of the null is effectively increased, and the interference reduction effect can be expected over a wider range, thereby achieving high robustness against the movement and rotation of the body of the HAPS 10.

### [Null Forming Method B-2]

When performing the multi-null forming, the number of optimal null candidates and their directions are different for each terrestrial cell 300C. The fourth null forming method B-2 is a multi-null forming method suitable for the case where the number and directions of such optimal null candidates are different for each terrestrial cell 300C.

The null forming method B-2 is a method for changing at least one of the number and direction of nulls that are simultaneously formed for each terrestrial cell 300C in the multi-null forming of the null forming method B-1. For example, the null forming method B-2 may be a method of changing at least one of the number and direction of nulls formed at the same time, based on at least one of the following B-2(1) to B-2(3).
B-2(1): Distance between the HAPS 10 and the terrestrial cell 300C.
B-2(2): User distribution within the terrestrial cell 300C.
B-2(3): Shape of the terrestrial cell 300C.

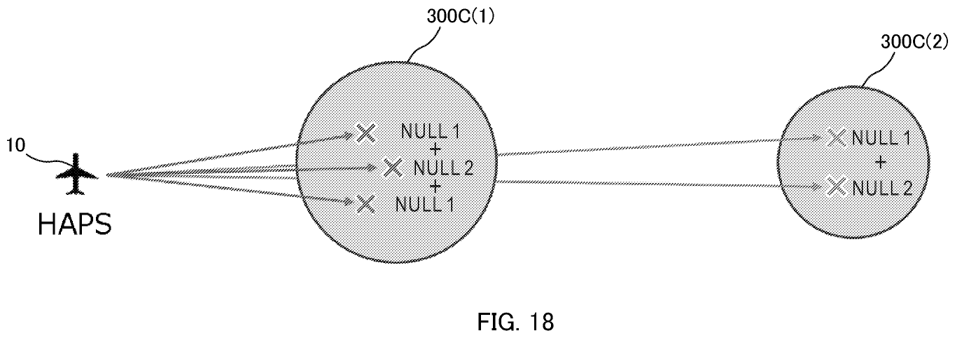

For example, the example of FIG. 18 is an example in which the number of nulls formed at the same time for the terrestrial cell 300C is changed according to the distance between the HAPS and the terrestrial cell. In the example of FIG. 18, the number of nulls formed at the same time for the terrestrial cell 300C(1) close to the HAPS 10 is three, and the number of nulls formed at the same time for the terrestrial cell 300C(2) far from the HAPS 10 is two.

According to the null forming method B-2, the number of nulls for each terrestrial cell 300C is adaptively controlled, thereby improving the performance of the terrestrial cell 300C. Since an increase in the number of nulls formed at the same time is equivalent to a reduction in the degrees of freedom of the service link antenna (array antenna) mounted on the HAPS 10, by not unnecessarily increasing the number of nulls, the reduction in the communication capacity of the relay communication station 110 of the HAPS 10 (SINR of users within the HAPS cell) can be kept to a minimum.

### [Null Forming Method C-1]

The fifth null forming method C-1 is a combination of the null sweeping of the first null forming method A-1 and the multi-null forming of the third null forming method B-1, which are described above. The null forming method C-1 is a method in which two or more nulls are selected per radio resource (time/frequency resource) from among plural null candidates with different directions (hereinafter, a set of selected nulls is referred to as a “null group”), and when directing the null from the HAPS 10 in the direction of the terrestrial cell 300C, the null groups are switched on the time axis, on the frequency axis, or on both axes.

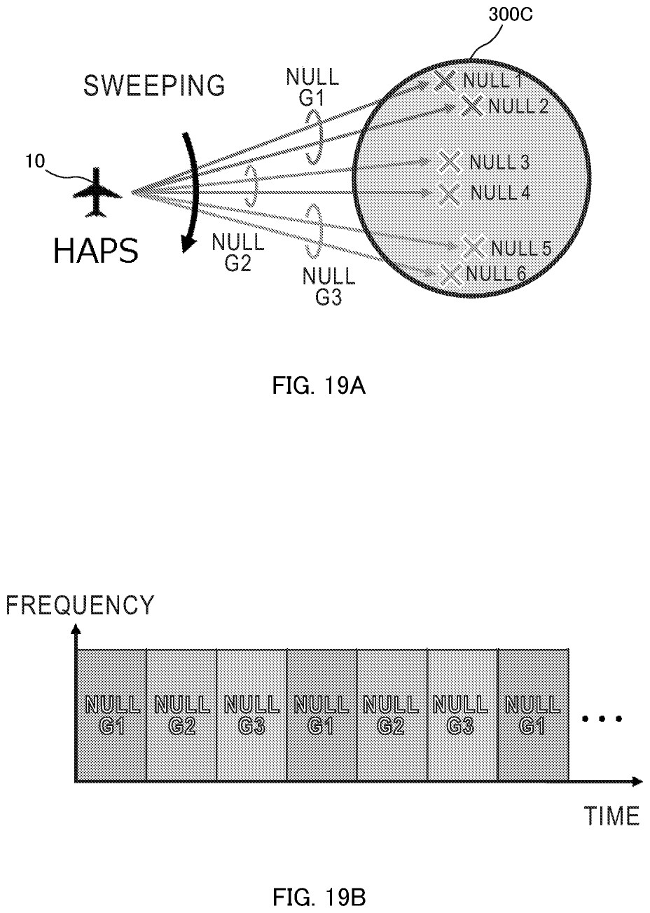

For example, in the examples of FIGS. 19A and 19B, there are six null candidates 1 to 6 with different directions, and three candidates of null groups G1 to G3, and when directing the null from the HAPS 10 in the direction of the terrestrial cell 300C, one null group is selected per radio resource (time/frequency resource) from among the three candidates of null groups G1 to G3, and the null groups are switched on the time axis.

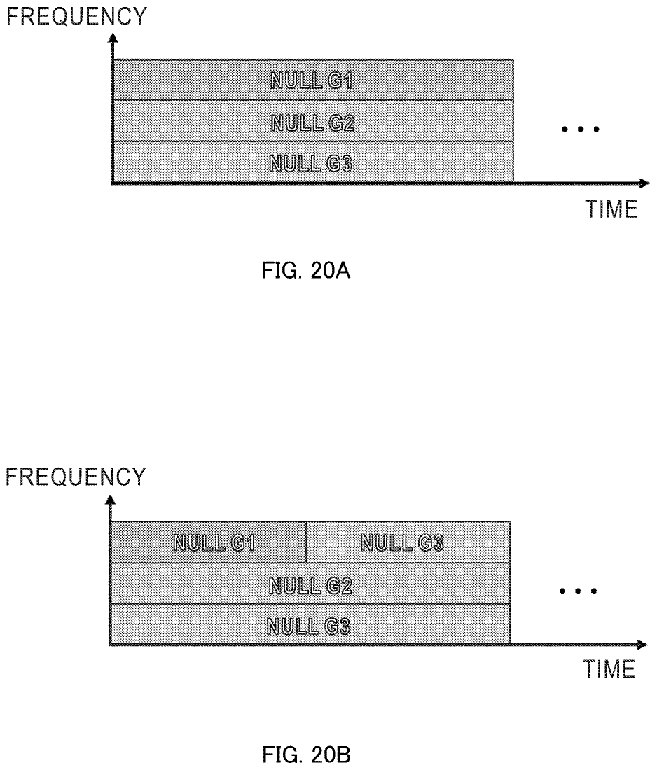

Each of FIGS. 20A and 20B is an illustration showing an application example of multi-null sweeping in the fifth null forming method C-1. In the example of FIG. 19B described above, the three null groups G1, G2 and G3, which are selected on the radio resource basis, are switched on the time axis, whereas in the example of FIG. 20A, the null groups G1, G2, and G3 selected in radio resource units are switched on the frequency axis. In the example of FIG. 20B, the null groups G1, G2, and G3, which are selected on radio resource basis, are switched on both the time axis and the frequency axis.

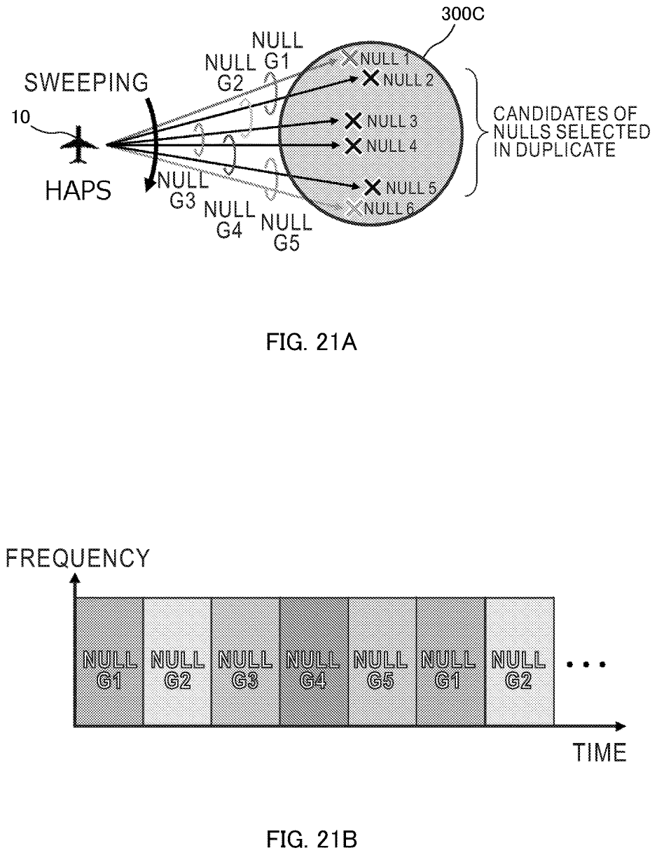

It is noted that, for the null group in the null forming method C-1, any two or more nulls may be selected from the null candidates, or a null may be selected in duplicate. For example, in the example of FIG. 21A, there are five candidates of null groups G1 to G5, and four candidates of nulls 2 to 5 are selected in duplicate to the null group, among six candidates of nulls 1 to 6. For example, the candidate of the null 2 is selected in duplicate to two null groups G1 and G2. In the example of FIG. 21B, when directing the null from the HAPS 10 in the direction of the terrestrial cell 300C, one null group is selected per radio resource (time/frequency resource) from among five candidates of null groups G1 to G5, and the null groups are switched on the time axis.

According to the null forming method C-1, the same effects as those of the null forming method A-1 and the null forming method B-1 described above can be obtained.

### [Null Forming Method C-2]

The sixth null forming method C-2 is a combination of the null sweeping of the second null forming method A-2 and the multi-null forming of the fourth null forming method B-2 described above. That is, the null forming method C-2 is a method of performing the multi-null sweeping and changing the number of nulls formed at the same time for each terrestrial cell 300C and the number of groups of nulls to be swept. When performing the multi-null sweeping, the number of optimal null candidates and their directions, as well as the number of null groups to be swept, are different for each terrestrial cell 300C.

The null forming method C-2 may be a method of changing the number of null candidates, their direction, and the number of null groups to be swept in the null forming method C-1, based on at least one of the following C-2(1) to C-2(3).
C-2(1): Distance between the HAPS 10 and the terrestrial cell 300C.
C-2(2): User distribution within the terrestrial cell 300C.
C-2(3): Shape of the terrestrial cell 300C.

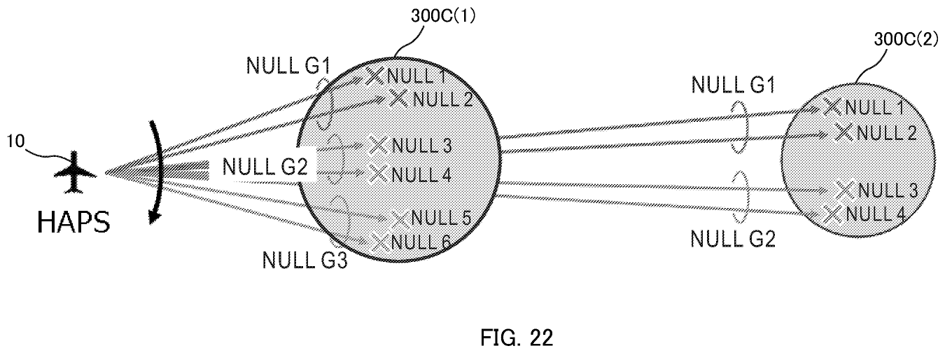

For example, the example of FIG. 22 is an example in which the number of nulls formed at the same time for the terrestrial cell 300C is changed according to the distance between the HAPS and the terrestrial cell. In the example of FIG. 20, the number of candidates for nulls 1 to 6 formed for the terrestrial cell 300C(1) close to the HAPS 10 is six, and the number of null groups G1 to G3 to be swept is three. On the other hand, the number of candidates for nulls 1 to 4 formed for the terrestrial cell 300C(2) far from the HAPS 10 is four, and the number of null groups G1 and G2 to be swept is two.

According to the null forming method C-2, the same effects as those of the null forming method A-2 and the null forming method B-2 described above can be obtained.

### [Configuration and Processing Flow of Overall System]

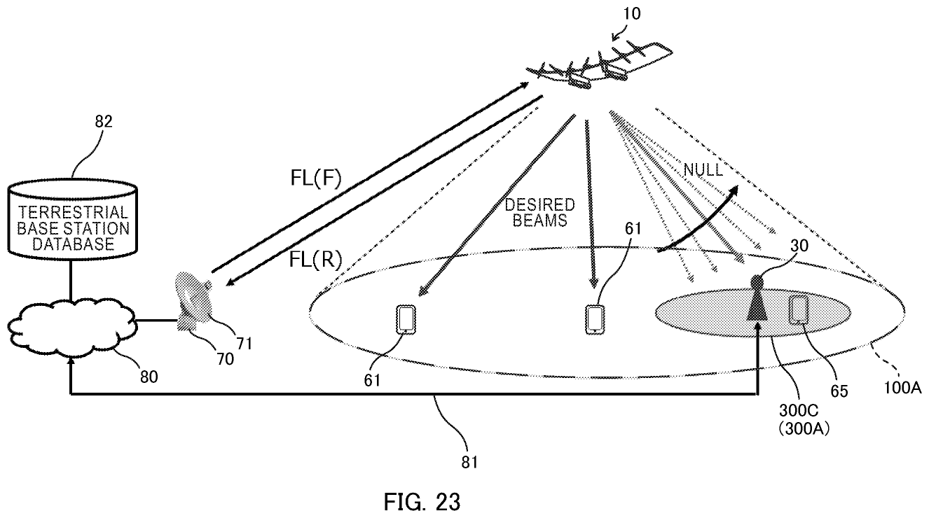

FIG. 23 is an illustration showing an example of an overall configuration of a communication system having a terrestrial base station database 82 according to the embodiment. It is noted that, in FIG. 23, the same parts as those in FIG. 1 described above are denoted by the same reference numerals, and the description thereof is omitted. In addition, although FIG. 23 shows a case where the relay communication station 110 mounted in the HAPS 10 is a base station apparatus-type relay communication station having a base station apparatus, the relay communication station 110 mounted in the HAPS 10 may also be a repeater-type relay communication station. In this case, the base station apparatus is provided in the relay communication station 110 mounted in the HAPS 10 and a terrestrial feeder station (gateway station) 70, etc., and the wide-area cell base station (HAPS base station) includes the repeater-type relay communication station mounted in the HAPS 10 and the base station apparatus on the ground.

In FIG. 23, the HAPS 10 can perform a notification to the terrestrial base station 30 via the feeder station (gateway station) 70, the mobile communication network 80 and a backhaul line 81. The HAPS 10 can access the terrestrial base station database 82 via the feeder station (gateway station) 70 and the mobile communication network 80 to obtain information on the terrestrial base stations 30. The terrestrial base station 30 can notify the HAPS 10 of switching information between UL and DL in the terrestrial cell 300C via the backhaul line 81, the mobile communication network 80 and the feeder station (gateway station) 70.

The HAPS 10 and the terrestrial base station 30 share, for example, information (hereinafter referred to as “notification information”) I1 that is periodically notified from the HAPS 10 to the terrestrial base station 30, and information (hereinafter referred to as “DB information”) I2 that is stored in the terrestrial base station database 82.

The notification information I1 depends on the user scheduling algorithm of the terrestrial base station 30, and may be, for example, the following information (I1-1) to (I1-3).
(I1-1) Position information and three-dimensional rotation information of the body of the HAPS 10 at time t.
(I1-2) Number for identifying the null applied to radio resource (time/frequency resource) i.
(I1-3) Information required for estimating the interference power from the HAPS 10 in radio resource (time/frequency resource) i.

The information (I1-3) required for estimating the interference power from the HAPS 10 is, for example, the following information (I1-3-1) to (I1-3-4).
(I1-3-1) Precoding weight matrix applied to radio resource (time/frequency resource) i.
(I1-3-2) Precoding weight matrix obtained by statistically processing the information (I1-3-1) in order to reduce the amount of information to be notified.
(I1-3-3) Information sufficient to reconstruct the shape of the null formed in radio resource (time/frequency resource) i in two or three dimensions at the terrestrial base station side.
(I1-3-4) Information obtained by statistically processing the information (I1-3-3) in order to reduce the amount of information to be notified.

The information 12 stored in the terrestrial base station database 82 is information referenced by the HAPS 10, and is, for example, the following information (I2-1) to (I2-3).
(I2-1) Coordinates of the terrestrial base station 30.
(I2-2) Cell radius of the terrestrial base station 30.
(I2-1) Geographic distribution of users connected to the terrestrial base station 30 (changes over time).

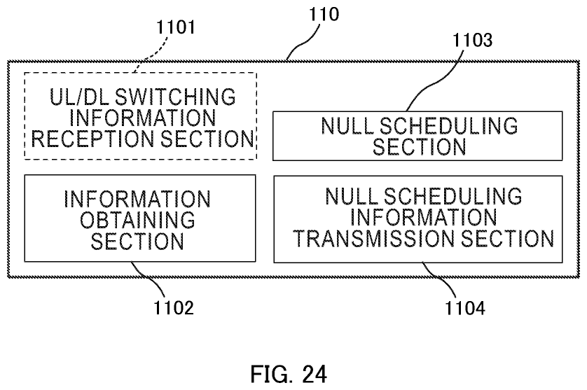

FIG. 24 is a block diagram showing an example of a main configuration of the base station apparatus-type relay communication station 110 mounted in the HAPS 10 in the communication system of FIG. 23. FIG. 24 is a configuration example when operating in the TDD communication method. In FIG. 24, the relay communication station 110 is provided with a UL/DL switching information reception section 1101, an information obtaining section 1102 of the terrestrial base station, a null scheduling section 1103 and a null-scheduling information transmission section 1104. The UL/DL switching information reception section 1101 receives UL/DL switching information from each terrestrial base station 30 via the feeder link FL. The information obtaining section 1102 of the terrestrial base station accesses the terrestrial base station database 82 via the feeder link FL, and obtains information about the terrestrial base stations located in the own service area 100A (HAPS cell 100C). The null scheduling section 1103 determines the allocation (scheduling) of nulls on the time axis and frequency axis for each terrestrial base station, based on the UL/DL switching information received from each terrestrial base station 30 and the information on the terrestrial base station obtained from the terrestrial base station database 82. The null-scheduling information transmission section 1104 notifies each terrestrial base station 30 of the null scheduling information via the feeder link FL and the mobile communication network (network) 80.

It is noted that, in FIG. 24, in the case of operating in the FDD communication method, the UL/DL switching information reception section 1101 is not necessary.

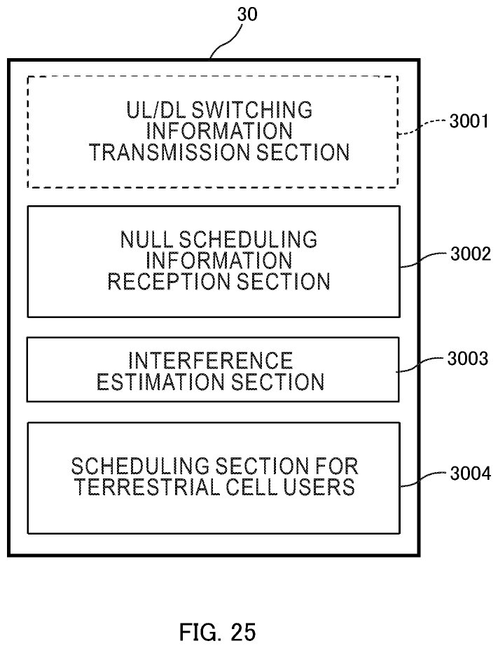

FIG. 25 is a block diagram showing an example of a main configuration of the terrestrial base station 30 in the communication system of FIG. 23. FIG. 25 is a configuration example when operating in the TDD communication method. In FIG. 25, the terrestrial base station 30 is provided with a UL/DL switching information transmission section 3001, a null-scheduling information reception section 3002, an interference estimation section 3003 and a scheduling section 3004 for terrestrial cell users. The UL/DL switching information transmission section 3001 notifies the HAPS 10 of UL/DL of switching information in the terrestrial cell of the own cell. The null-scheduling information reception section 3002 receives null scheduling information relating to the own terrestrial base station 30 from the HAPS 10. The interference estimation section 3003 estimates the interference from the HAPS 10 to a user (UE 65) located in the own cell, based on the null scheduling information. The scheduling section 3004 for terrestrial cell users determines user allocation (scheduling) on the time axis and on the frequency axis.

It is noted that, in FIG. 25, in the case of operating in the FDD communication method, the UL/DL switching information transmission section 3001 is not necessary.

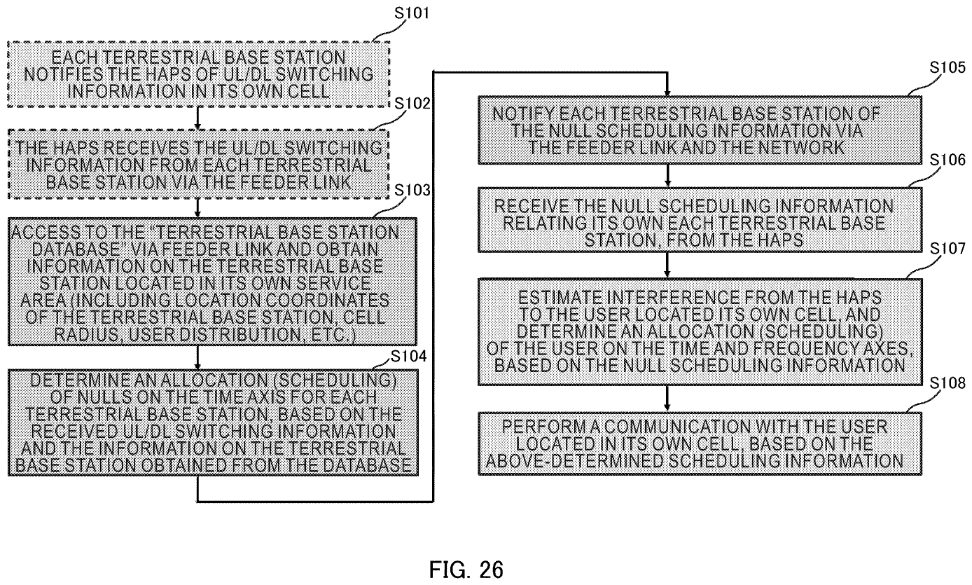

FIG. 26 is a flowchart showing an example of a processing flow in the HAPS base station and the terrestrial cell base station when performing the beamforming control and service link communication involving the null formation in the communication system according to the embodiment. FIG. 26 is an example of a processing flow when operating in the TDD communication method.

In FIG. 26, each terrestrial base station 30 notifies the HAPS 10 of UL/DL switching information in the own cell (S101).

Next, the HAPS 10 receives UL/DL switching information from each terrestrial base station 30 via the feeder link FL (S102).

Next, the HAPS 10 accesses the terrestrial base station database 82 via the feeder link FL, and obtains information on the terrestrial base stations 30 located in the own service area 100A (HAPS cell 100C) (S103). The information to be obtained includes the coordinates, the cell radius, the user distribution of the terrestrial base station 30, and the like.

Next, the HAPS 10 determines the allocation (scheduling) of nulls on the time axis and the frequency axis for each terrestrial base station, based on the UL/DL switching information received from each terrestrial base station 30 and the information on the terrestrial base station 30 obtained from the terrestrial base station database 82 (S104).

Next, the HAPS 10 notifies each terrestrial base station 30 of the null scheduling information via the feeder link FL and the mobile communication network (network) 80 (S105).

Next, the terrestrial base station 30 receives the null scheduling information relating to the own terrestrial base station 30 from the HAPS 10 (S106).

Next, the terrestrial base station 30 estimates the interference from the HAPS 10 to the user (UE 65) located in the own cell, based on the null scheduling information, and determines the user allocation (scheduling) on the time axis and frequency axis (S107).

Next, the terrestrial base station 30 communicates with the user (UE 65) located in the own cell based on the scheduling information determined in step S107 (S108).

It is noted that, in FIG. 26, in the case of operating in the FDD communication method, the steps of transmitting and receiving the UL/DL switching information (S101, S102) are not necessary.

### [Resource Control Algorithm]

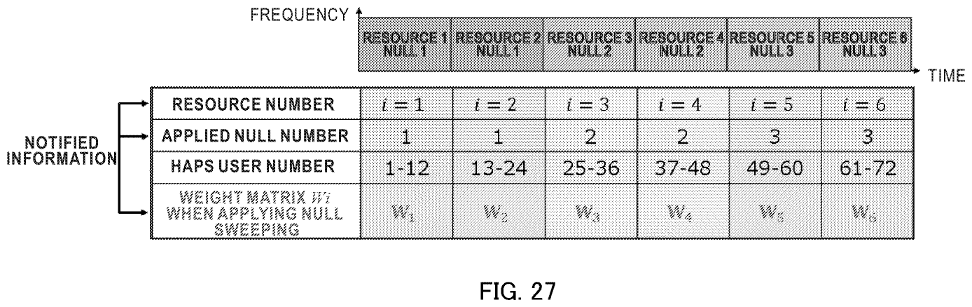

FIG. 27 is an illustration showing an example of a resource control algorithm that takes the null sweeping into consideration. The resource control algorithm of the present example is based on the premise that the following information (I1-1) to (I1-3) is periodically notified from the HAPS 10 to each terrestrial base stations 30.
(I1-1) Position information and 3D rotation information of the body of the HAPS 10.
(I1-2) Null number applied to the radio resource (time/frequency resource) i.
(I1-3) Weight matrix Wi when applying the null sweeping in the radio resource (time/frequency resource) i.

The weight matrix Wi when applying the null sweeping is expressed, for example, by the following equation (1), is calculated on the HAPS 10 side, and is uniquely determined by a combination of the null direction and the HAPS user (user located in the HAPS cell). Herein, Nt is the number of elements of the array antenna (service link antenna) 130 of the HAPS 10, and Nu is the number of spatial multiplexing (the number of HAPS users).

$${W}_{i} ∈ {ℂ}^{{N}_{u} \times {N}_{t}} \qquad ( 1 )$$

For example, when the number of time resources is six, the number of frequency resources is one and the number of spatial multiplexing Nu is twelve, as shown in FIG. 27, the HAPS 10 calculates weight matrices W₁ to W₆ when applying the null sweeping, and notifies each terrestrial base station 30 of the calculated weight matrices together with the resource number, the applied null number and the HAPS user number.

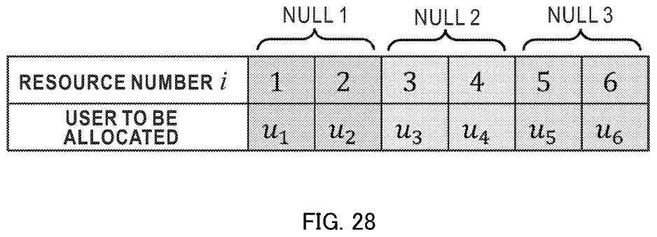

The user scheduling algorithm in the terrestrial base station 30 can be performed as follows. For example, as shown in FIG. 28, the resource number i, the terrestrial base station user number u, and the user number uᵢ allocated to the resource number i are set as follows.
Resource number i∈{1, 2, 3, 4, 5, 6}
Terrestrial base station user number u∈{1, 2, 3, 4, 5, 6}
User number uᵢ allocated to resource i

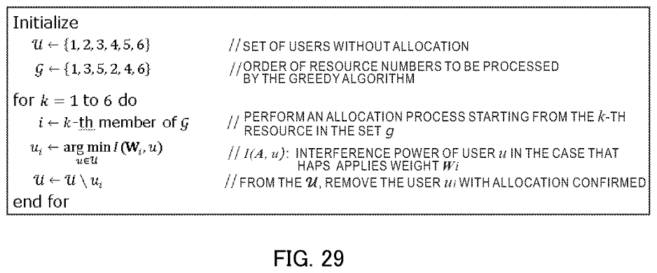

Under the above settings, as exemplified by the program code of the user scheduling algorithm in FIG. 29, a user can be sequentially selected, in which an interference power is minimized when a certain resource i is allocated, by a greedy method.

In the example of the user scheduling algorithm in FIG. 29, first, an initialization process is executed including a setting of a first set of user numbers u of terminal apparatuses of plural (N) unallocated users and a setting of a second set of resource numbers i in order of the plural (N) radio resources to be processed by the greedy method. Next, a process is executed for setting a k-th resource number k of the second set as a resource number i of a user allocation target in order of the first (k=1) to the N-th (k=N) of the resource numbers i of the second set, allocating a user number u of a terminal apparatus of a user, for which an estimated interference power is minimized when the radio resource of the resource number i is allocated, as a user number uᵢ to be allocated to the resource number i, and deleting the user number uᵢ for which an allocation has been confirmed from the first set.

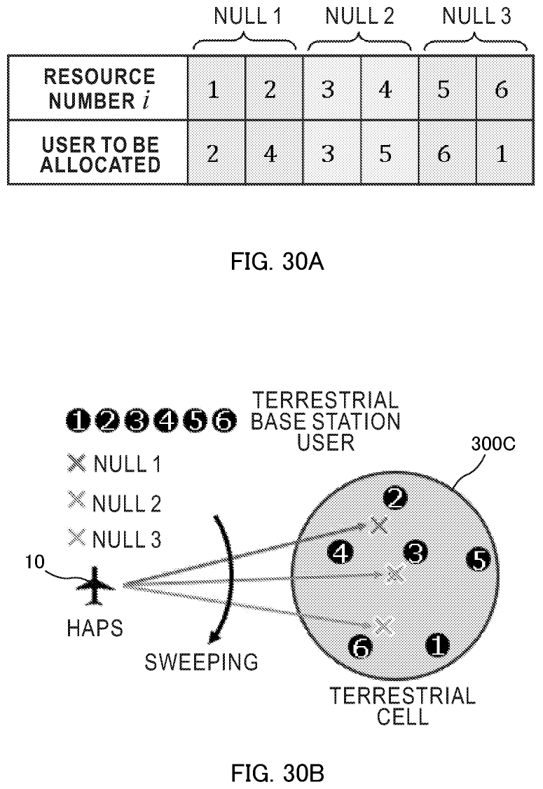

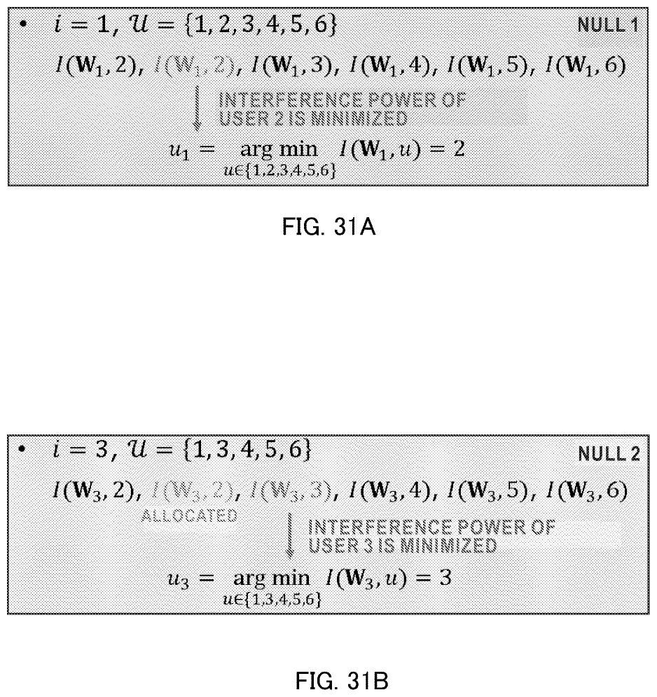

When determining the scheduling for terrestrial base station users 1 to 6 shown in FIG. 30B based on the null scheduling shown in FIG. 30A, in the execution example of the user scheduling algorithm, first, as shown in the algorithm for resource 1 of null 1 in FIG. 31A, user 2 is allocated to resource 1 because the interference power of user 2 is minimal.

After the allocation of user 2 to resource 1 is determined, as shown in the algorithm for resource 3 of null 2 in FIG. 31B, user 3 is allocated to resource 3 because the interference power of user 3 is the smallest.

Thereafter, the user scheduling algorithm is repeated until all remaining users have been allocated resources. This completes the allocation of resources to all terrestrial base station users (users located in the terrestrial cell) 1 to 6 located in the terrestrial cell 300C in FIG. 30B, as shown in FIG. 30A.

As described above, according to the present embodiment, in the case that the terrestrial cell formed by the antenna of the terrestrial base station using the same frequency band is positioned within the cell 100C formed from the HAPS 10 in the upper airspace toward on the ground or on the sea, the interference from the HAPS 10 to the terrestrial cell (the terrestrial base station 30 and the UE 65 connected to that terrestrial base station) can be suppressed.

In particular, according to the present embodiment, it is possible to reduce the residual interference when forming the null of the directional beam from the relay communication station 110 mounted in the HAPS 10 in the upper airspace toward the coverage area of the terrestrial cell base station 30.

The present invention can provide a system capable of reducing the residual interference when forming the null of the directional beam from the relay communication station 110 mounted in the HAPS 10 in the upper airspace toward the coverage area of the terrestrial cell base station 30, so it is possible to contribute to achieving Goal 9 of the Sustainable Development Goals (SDGs), which is to “Create a foundation for industry and technological innovation”.

It is noted that, the process steps and configuration elements of the relay communication station of the communication relay apparatus such as the HAPS 10, the feeder station, the gateway station, the management apparatus, the surveillance apparatus, the remote control apparatus, the server, the terminal apparatus (UE: user apparatus, mobile station, communication terminal), the base station and the base station apparatus described in the present description can be implemented with various means. For example, these process steps and configuration elements may be implemented with hardware, firmware, software, or a combination thereof.

With respect to hardware implementation, means such as processing units or the like used for establishing the foregoing steps and configuration elements in entities (for example, relay communication station, feeder station, gateway station, base station, base station apparatus, relay-communication station apparatus, terminal apparatus (UE: user apparatus, mobile station, communication terminal), management apparatus, monitoring apparatus, remote control apparatus, server, hard disk drive apparatus, or optical disk drive apparatus) may be implemented in one or more of an application-specific IC (ASIC), a digital signal processor (DSP), a digital signal processing apparatus (DSPD), a programmable logic device (PLD), a field programmable gate array (FPGA), a processor, a controller, a microcontroller, a microprocessor, an electronic device, other electronic unit, computer, or a combination thereof, which are designed so as to perform a function described in the present specification.

With respect to the firmware and/or software implementation, means such as processing units or the like used for establishing the foregoing configuration elements may be implemented with a program (for example, code such as procedure, function, module, instruction, etc.) for performing a function described in the present specification. In general, any computer/processor readable medium of materializing the code of firmware and/or software may be used for implementation of means such as processing units and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage unit, or the like. The code may be executed by one or more of computers and processors, and a certain aspect of functionalities described in the present specification may by executed by a computer or processor.

The medium may be a non-transitory recording medium. Further, the code of the program may be executable by being read by a computer, a processor, or another device or an apparatus machine, and the format is not limited to a specific format. For example, the code of the program may be any of a source code, an object code, and a binary code, and may be a mixture of two or more of those codes.

The description of embodiments disclosed in the present specification is provided so that the present disclosures can be produced or used by those skilled in the art. Various modifications of the present disclosures are readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: HAPS
30: terrestrial base station (terrestrial cell base station)
70: feeder station (GW station)
71: antenna
80: mobile communication network (network)
81: backhaul line
82: terrestrial base station database
100A: service area
100B: beam
100C: HAPS cell (3D cell)
100F: footprint
110: relay communication station
130: array antenna (service link antenna)
130a: antenna element
300C: terrestrial cell

1.-2. (canceled)

3. The system according to claim 4,
wherein the wide-area cell base station selects a null forming method for forming a single null toward the antenna of the terrestrial cell base station, with respect to radio resources in which communication directions of the uplink (UL) and the downlink (DL) are different between the wide-area cell and the terrestrial cell, among radio resources in the radio frame of the own station.

4. A system comprising a wide-area cell base station that a flying body or floating body located in an upper airspace toward on a ground or on a sea, and one or plural terrestrial cell base stations that form a terrestrial cell from an antenna disposed on the ground or on the sea,
wherein the wide-area cell base station and the one or plural terrestrial cell base stations perform service link communications in a same frequency band using radio frames that are time-synchronized with each other, and
wherein the wide-area cell base station:
selects a null forming method for switching and forming plural nulls with different directions toward the terrestrial cells according to at least one of time and frequency, with respect to radio resources in which communication directions of the uplink (UL) and the downlink (DL) are the same between the wide-area cell and the terrestrial cell, among radio resources in the radio frame of the own station, and
controls a beamforming by the service link antenna of the relay communication station so as to form a null toward within a coverage area of the terrestrial cell base station based on the null forming method.

5. The system according to claim 4,
wherein the wide-area cell base station changes the number of nulls to be switched and formed for each of the terrestrial cells.

6. A system comprising a wide-area cell base station that a flying body or floating body located in an upper airspace toward on a ground or on a sea, and one or plural terrestrial cell base stations that form a terrestrial cell from an antenna disposed on the ground or on the sea,
wherein the wide-area cell base station and the one or plural terrestrial cell base stations perform service link communications in a same frequency band using radio frames that are time-synchronized with each other, and
wherein the wide-area cell base station:
selects a null forming method for forming plural nulls at the same time for each of the terrestrial cells, with respect to radio resources in which communication directions of the uplink (UL) and the downlink (DL) are the same between the wide-area cell and the terrestrial cell, among radio resources in the radio frame of the own station, and
controls a beamforming by the service link antenna of the relay communication station so as to form a null toward within a coverage area of the terrestrial cell base station based on the null forming method.

7. The system according to claim 6,
wherein the wide-area cell base station changes the number of nulls to be formed at the same time for each of the terrestrial cells.

8. A system comprising a wide-area cell base station that a flying body or floating body located in an upper airspace toward on a ground or on a sea, and one or plural terrestrial cell base stations that form a terrestrial cell from an antenna disposed on the ground or on the sea,
wherein the wide-area cell base station and the one or plural terrestrial cell base stations perform service link communications in a same frequency band using radio frames that are time-synchronized with each other, and
wherein the wide-area cell base station:
selects a null forming method for switching and forming null groups for each of the terrestrial cells according to at least one of time and frequency when forming plural nulls at the same time for each of the terrestrial cells, with respect to radio resources in which communication directions of the uplink (UL) and the downlink (DL) are the same between the wide-area cell and the terrestrial cell, among radio resources in the radio frame of the own station, and
controls a beamforming by the service link antenna of the relay communication station so as to form a null toward within a coverage area of the terrestrial cell base station based on the null forming method.

9. The system according to claim 8,
wherein the wide-area cell base station changes, for each of the terrestrial cells, at least one of the number of nulls to be formed at the same time and the number of nulls to be switched and formed.

10. The system according to claim 4,
wherein each of the plural terrestrial cell base stations:
performs the service link communication by a Time Division Duplex (TDD) method; and
transmits switching information on uplink (UL) and downlink (DL) of the own cell, to the wide-area cell base station, and
wherein the wide-area cell base station:
receives the switching information on uplink (UL) and downlink (DL) from each of the plural terrestrial cell base stations;
obtains information related to terrestrial cell base stations located in the wide-area cell from a terrestrial cell base station database;
determines a null scheduling regarding an allocation of nulls on a time axis and a frequency axis for each of the terrestrial cell base stations, based on the switching information on uplink (UL) and downlink (DL) received from each of the plural terrestrial cell base stations and the information related to the terrestrial cell base stations obtained from the terrestrial cell base station database; and
transmits null scheduling information to each of the plural terrestrial cell base stations, and
wherein each of the plural terrestrial cell base stations:
receives the null scheduling information related to the own terrestrial cell base station from the wide-area cell base station;
estimates an interference from the wide-area cell to a terminal apparatus of a user located in the own cell, based on the null scheduling information, and determines a user scheduling related to an allocation of the terminal apparatus of the user on a time axis and a frequency axis; and
communicates with the terminal apparatus of the user located in the own cell based on the user scheduling information.

11. The system according to claim 10,
wherein, in the user scheduling, the terrestrial cell base station performs:
an initialization process including a setting of a first set of user numbers u of terminal apparatuses of plural (N) unallocated users and a setting of a second set in order of resource numbers i for plural (N) radio resources processed by a greedy method; and
a process for setting a k-th resource number k of the second set as a resource number i of a user allocation target in order of first (k=1) to N-th (k=N) of the resource numbers i of the second set, allocating a user number u of a terminal apparatus of a user, for which an estimated interference power is minimized when the radio resource of the resource number i is allocated, as a user number uᵢ to be allocated to the resource number i, and deleting the user number uᵢ for which an allocation is confirmed, from the first set.

12. The system according to claim 4,
wherein each of the plural terrestrial cell base stations performs a service link communication by a Frequency Division Duplex (FDD) method,
wherein the wide-area cell base station:
obtains information related to plural terrestrial cell base stations located in the wide-area cell from a terrestrial cell base station database;
determines, for each of the terrestrial cell base stations, a null scheduling regarding an allocation of nulls on a time axis and a frequency axis, based on the information related to the terrestrial cell base stations obtained from the terrestrial cell base station database; and
transmits null scheduling information to each of the plural terrestrial cell base stations, and
wherein each of the plural terrestrial cell base stations:
receives the null scheduling information related to the own station from the wide-area cell base station;
estimates an interference from the wide area cell to terminal apparatuses of users located in the own cell, based on the null scheduling information, and determines a user scheduling related to an allocation of the terminal apparatus of the user on a time axis and a frequency axis; and
communicates with the terminal apparatus of the user located in the own cell based on the user scheduling information.

13. The system according to claim 12,
wherein, in the user scheduling, the terrestrial cell base station performs:
an initialization process including a setting of a first set of user numbers u of terminal apparatuses of plural (N) unallocated users and a setting of a second set in order of resource numbers i for plural (N) radio resources processed by a greedy method; and
a process for setting a k-th resource number k of the second set as a resource number i of a user allocation target in order of first (k=1) to N-th (k=N) of the resource numbers i of the second set, allocating a user number u of a terminal apparatus of a user, for which an estimated interference power is minimized when the radio resource of the resource number i is allocated, as a user number uᵢ to be allocated to the resource number i, and deleting the user number uᵢ for which an allocation is confirmed, from the first set.

14. The system according to claim 6,
wherein the wide-area cell base station selects a null forming method for forming a single null toward the antenna of the terrestrial cell base station, with respect to radio resources in which communication directions of the uplink (UL) and the downlink (DL) are different between the wide-area cell and the terrestrial cell, among radio resources in the radio frame of the own station.

15. The system according to claim 8,
wherein the wide-area cell base station selects a null forming method for forming a single null toward the antenna of the terrestrial cell base station, with respect to radio resources in which communication directions of the uplink (UL) and the downlink (DL) are different between the wide-area cell and the terrestrial cell, among radio resources in the radio frame of the own station.

16. The system according to claim 6,
wherein each of the plural terrestrial cell base stations:
performs the service link communication by a Time Division Duplex (TDD) method; and
transmits switching information on uplink (UL) and downlink (DL) of the own cell, to the wide-area cell base station, and
wherein the wide-area cell base station:
receives the switching information on uplink (UL) and downlink (DL) from each of the plural terrestrial cell base stations;
obtains information related to terrestrial cell base stations located in the wide-area cell from a terrestrial cell base station database;
determines a null scheduling regarding an allocation of nulls on a time axis and a frequency axis for each of the terrestrial cell base stations, based on the switching information on uplink (UL) and downlink (DL) received from each of the plural terrestrial cell base stations and the information related to the terrestrial cell base stations obtained from the terrestrial cell base station database; and
transmits null scheduling information to each of the plural terrestrial cell base stations, and
wherein each of the plural terrestrial cell base stations:
receives the null scheduling information related to the own terrestrial cell base station from the wide-area cell base station;
estimates an interference from the wide-area cell to a terminal apparatus of a user located in the own cell, based on the null scheduling information, and determines a user scheduling related to an allocation of the terminal apparatus of the user on a time axis and a frequency axis; and
communicates with the terminal apparatus of the user located in the own cell based on the user scheduling information.

17. The system according to claim 16,
wherein, in the user scheduling, the terrestrial cell base station performs:
an initialization process including a setting of a first set of user numbers u of terminal apparatuses of plural (N) unallocated users and a setting of a second set in order of resource numbers i for plural (N) radio resources processed by a greedy method; and
a process for setting a k-th resource number k of the second set as a resource number i of a user allocation target in order of first (k=1) to N-th (k=N) of the resource numbers i of the second set, allocating a user number u of a terminal apparatus of a user, for which an estimated interference power is minimized when the radio resource of the resource number i is allocated, as a user number uᵢ to be allocated to the resource number i, and deleting the user number uᵢ for which an allocation is confirmed, from the first set.

18. The system according to claim 6,
wherein each of the plural terrestrial cell base stations performs a service link communication by a Frequency Division Duplex (FDD) method,
wherein the wide-area cell base station:
obtains information related to plural terrestrial cell base stations located in the wide-area cell from a terrestrial cell base station database;
determines, for each of the terrestrial cell base stations, a null scheduling regarding an allocation of nulls on a time axis and a frequency axis, based on the information related to the terrestrial cell base stations obtained from the terrestrial cell base station database; and
transmits null scheduling information to each of the plural terrestrial cell base stations, and
wherein each of the plural terrestrial cell base stations:
receives the null scheduling information related to the own station from the wide-area cell base station;
estimates an interference from the wide area cell to terminal apparatuses of users located in the own cell, based on the null scheduling information, and determines a user scheduling related to an allocation of the terminal apparatus of the user on a time axis and a frequency axis; and
communicates with the terminal apparatus of the user located in the own cell based on the user scheduling information.

19. The system according to claim 18,
wherein, in the user scheduling, the terrestrial cell base station performs:
an initialization process including a setting of a first set of user numbers u of terminal apparatuses of plural (N) unallocated users and a setting of a second set in order of resource numbers i for plural (N) radio resources processed by a greedy method; and
a process for setting a k-th resource number k of the second set as a resource number i of a user allocation target in order of first (k=1) to N-th (k=N) of the resource numbers i of the second set, allocating a user number u of a terminal apparatus of a user, for which an estimated interference power is minimized when the radio resource of the resource number i is allocated, as a user number uᵢ to be allocated to the resource number i, and deleting the user number uᵢ for which an allocation is confirmed, from the first set.

20. The system according to claim 8,
wherein each of the plural terrestrial cell base stations:
performs the service link communication by a Time Division Duplex (TDD) method; and
transmits switching information on uplink (UL) and downlink (DL) of the own cell, to the wide-area cell base station, and
wherein the wide-area cell base station:
receives the switching information on uplink (UL) and downlink (DL) from each of the plural terrestrial cell base stations;
obtains information related to terrestrial cell base stations located in the wide-area cell from a terrestrial cell base station database;
determines a null scheduling regarding an allocation of nulls on a time axis and a frequency axis for each of the terrestrial cell base stations, based on the switching information on uplink (UL) and downlink (DL) received from each of the plural terrestrial cell base stations and the information related to the terrestrial cell base stations obtained from the terrestrial cell base station database; and
transmits null scheduling information to each of the plural terrestrial cell base stations, and
wherein each of the plural terrestrial cell base stations:
receives the null scheduling information related to the own terrestrial cell base station from the wide-area cell base station;
estimates an interference from the wide-area cell to a terminal apparatus of a user located in the own cell, based on the null scheduling information, and determines a user scheduling related to an allocation of the terminal apparatus of the user on a time axis and a frequency axis; and
communicates with the terminal apparatus of the user located in the own cell based on the user scheduling information.

21. The system according to claim 20,
wherein, in the user scheduling, the terrestrial cell base station performs:
an initialization process including a setting of a first set of user numbers u of terminal apparatuses of plural (N) unallocated users and a setting of a second set in order of resource numbers i for plural (N) radio resources processed by a greedy method; and
a process for setting a k-th resource number k of the second set as a resource number i of a user allocation target in order of first (k=1) to N-th (k=N) of the resource numbers i of the second set, allocating a user number u of a terminal apparatus of a user, for which an estimated interference power is minimized when the radio resource of the resource number i is allocated, as a user number uᵢ to be allocated to the resource number i, and deleting the user number uᵢ for which an allocation is confirmed, from the first set.

22. The system according to claim 8,
wherein each of the plural terrestrial cell base stations performs a service link communication by a Frequency Division Duplex (FDD) method,
wherein the wide-area cell base station:
obtains information related to plural terrestrial cell base stations located in the wide-area cell from a terrestrial cell base station database;
determines, for each of the terrestrial cell base stations, a null scheduling regarding an allocation of nulls on a time axis and a frequency axis, based on the information related to the terrestrial cell base stations obtained from the terrestrial cell base station database; and
transmits null scheduling information to each of the plural terrestrial cell base stations, and
wherein each of the plural terrestrial cell base stations:
receives the null scheduling information related to the own station from the wide-area cell base station;
estimates an interference from the wide area cell to terminal apparatuses of users located in the own cell, based on the null scheduling information, and determines a user scheduling related to an allocation of the terminal apparatus of the user on a time axis and a frequency axis; and
communicates with the terminal apparatus of the user located in the own cell based on the user scheduling information.

23. The system according to claim 22,
wherein, in the user scheduling, the terrestrial cell base station performs:
an initialization process including a setting of a first set of user numbers u of terminal apparatuses of plural (N) unallocated users and a setting of a second set in order of resource numbers i for plural (N) radio resources processed by a greedy method; and
a process for setting a k-th resource number k of the second set as a resource number i of a user allocation target in order of first (k=1) to N-th (k=N) of the resource numbers i of the second set, allocating a user number u of a terminal apparatus of a user, for which an estimated interference power is minimized when the radio resource of the resource number i is allocated, as a user number uᵢ to be allocated to the resource number i, and deleting the user number uᵢ for which an allocation is confirmed, from the first set.
